(19) United States
(12) Patent Application Publication
(10) Pub. No.: US 2019/0375653 A1
(43) Pub. Date: Dec. 12, 2019

(54) Hierarchical Cellular Mesoporous Metal-Oxide Composites

(71) Applicant: West Virginia University, Morgantown, WV (US)

(72) Inventors: Maria Alejandra Torres Arango, Morgantown, WV (US); Konstantinos A. Sierros, Morgantown, WV (US)

(21) Appl. No.: 16/432,306

(22) Filed: Jun. 5, 2019

Related U.S. Application Data
(60) Provisional application No. 62/681,327, filed on Jun. 6, 2018.

(51) Int. Cl. C01G 23/047; C01B 13/32; C04B 35/46; C04B 38/00

(52) U.S. Cl. CPC C01G 23/047; C01B 13/32; C04B 35/46; C01P 2006/16; C04B 38/0054; C04B 2235/3232; C04B 2235/449; C04B 38/0045

(57) ABSTRACT

This invention provides hierarchical cellular mesoporous metal-oxide compositions. Preferably, the hierarchical cellular mesoporous metal-oxide compositions are either Ag—TiO₂ xanthum gum-based films or Ag—TiO₂ oil based foams. Methods of making the hierarchical cellular mesoporous metal-oxide compositions of Ag—TiO₂ xanthum gum-based films and Ag—TiO₂ oil based foams are provided.

### CROSS-REFERENCE TO RELATED APPLICATION

This patent application claims the benefit of priority to U.S. Provisional Patent Application Ser. No. 62/681,327, filed on Jun. 6, 2018. The entire contents of U.S. Provisional Patent Application Ser. No. 62/681,327, is incorporated by reference into this patent application as if fully written herein.

### STATEMENT REGARDING FEDERALLY SPONSORED RESEARCH

Not applicable.

### BACKGROUND OF THE INVENTION

### 1. Field of the Invention

This invention provides hierarchical mesoporous decorated metal-oxide compositions and a method of synthesis of these hierarchical mesoporous decorated metal-oxide compositions.

### 2. Description of the Background Art

Approaches to fabricate cellular metal-oxide structures or to decorate such ceramic scaffolds are conventionally treated as different processes and reported accordingly. The present invention produces decorated (functionalized) ceramic scaffolds in a single step avoiding such multi-step processes, reducing time and not requiring special vacuum conditions for the formation of the functionalizing materials.

The background art differs significantly from the present invention's compositions and methods of making the same, since the background art produces different output materials and uses mainly polymers that stay in the finished composition.

U.S. Pat. No. 4,889,670 Process for manufacturing green and ceramic foam.
CA1318079C Process for manufacturing green and ceramic foam.
CN102245333B Method for producing metal nanoparticles and nanoparticles obtained in this way and use thereof.
US 20120037041A1 Method for producing metal nanoparticles and nanoparticles obtained in this way and use thereof.
U.S. Pat. No. 8,870,998B2 Method for making monodispersed noble metal nanoparticles supported on oxide substrates.
US 20130130383A1 Ultrahigh surface area supports for nanomaterial attachment.
WO1999009070A1 High internal phase emulsions and porous materials prepared therefrom.
U.S. Pat. No. 6,353,037B1 Foams containing functionalized metal oxide nanoparticles and methods of making same.
U.S. Pat. No. 6,462,100B1 Foams containing functionalized metal oxide nanoparticles and methods of making same.
U.S. Pat. No. 7,160,929B1 Nanocomposite and molecular-composite polymer foams and method for their production.
US20070224678A1 Functionalized artificial bone and joint compositions and methods of use and manufacture.
U.S. Pat. No. 7,026,266B2 Catalytic formulation and its preparation.
US20130315972A1 Compositions and methods for antimicrobial metal nanoparticles.
US20170210872A1 Method for modifying the surface properties of elastomer cellular foams.
U.S. Pat. No. 6,660,224B2 Method of making open cell material.
U.S. Pat. No. 6,087,024A Method for forming porous sintered bodies with controlled pore structure.

### SUMMARY OF THE INVENTION

The synthesis of metal-oxide decorated heterostructures is currently a time consuming and multi-step process. Typically, ceramic (metal-oxide) scaffolds are prepared first and then the decorative materials are incorporated by using multiple and repetitive infiltration routes¹, or vapor-based deposition^{2,3}. Alternative procedures decorate the primary ceramic nanoparticles first, and later form the macroscopic scaffold by pressing and sintering the decorated particles/nanomaterials in the presence or absence of a binder. Such decoration may involve UV-light photo-reduction^{4,5}, sonochemical⁶ or thermal reduction processing^{7,8}. Pre-decoration of the ceramic nanomaterials is usually performed by placing such materials in solutions containing the decorative material precursors, and centrifugation-rinsing cycles are implemented after the decorative materials are synthesized⁸⁻¹¹, further adding steps in the processing and affecting the product yield.

With the invented method, the synthesis of hierarchical mesoporous decorated metal-oxide composites becomes a one-step process. In such step, the different composite precursors are mixed as a functional ink that can be 2D or 3D printed making the desired object/scaffold shape. Curing of this ink using UV-light or heat treatments serves two different functions: (1) to promote interconnectivity (bridging/coalescence) of the ceramic structure and (2) to induce the formation of the decorative secondary phase materials. It will be understood by those persons skilled in the art, that while the formulation of the inks requires several mixing steps, it is the synthesis of the decorated composites of this invention that is a “one step” process, since once the ink is formulated (containing all the precursors for the composites), the decorated composites are formed at once upon energy input. The synthesis of similar heterostructures relays on additional decorative materials deposition/infiltration and washing cycles.

The composites' of the present invention surface area properties, decorative material loading, and cellular configuration can be tuned via composition, by changing the relative amounts of precursors composing the multiphase systems. Because the decorated metal-oxide composites are made at a single mixing step, no centrifugation is necessary and the yield of the product is 100%, concomitantly avoiding the use of solvents and their release to the environment. Also, the precursors used are generally non-toxic and biocompatible, which makes them inherently safe and well suited for large scale materials processing, useful in a wide range of products, and facilitates their recycling and disposal.

These heterostructures may be used in applications such as H₂ generation^{1,12-16,} supercapacitors¹⁷, small molecule detection¹⁸, sensor active layers¹⁹, catalysis^{1,13,20-29} photovoltaics³⁰⁻³⁴, biomedicine^{35,36}, antibacterial coatings³⁷ and scaffolds for tissue engineering³⁸.

The compositions and methods of the present invention provide many advantages over the background art compositions, including but not limited to, a one step process for producing the compositions, low-cost, 100% yield, environment-friendly, a homogeneous dispersion, controlled positioning of the decorative materials, and transferability to other decorative materials/ceramic composite systems.

In one embodiment of this invention a composition comprising a hierarchical cellular mesoporous metal-oxide is provided. Preferably, this composition comprises wherein the hierarchical cellular mesoporous metal oxide is a metal organic/metal oxide.

In another embodiment of this invention, a composition comprising a hierarchical cellular mesoporous metal-oxide that is a metal organic/metal oxide that is TALH:TiO₂ is provided.

In another embodiment of this invention, a composition comprising a hierarchical cellular mesoporous metal-oxide is that is an Ag—TiO₂ xanthan gum based film is provided. Preferably, this composition comprises said hierarchical cellular mesoporous metal-oxide that is an Ag—TiO₂ oil based foam.

In another embodiment of this invention, a composition is provided comprising a hierarchical cellular mesoporous metal-oxide is the form of a three dimensional printed hierarchical based structure. Preferably, this composition comprises wherein said three dimensional structure is on a ITO/glass substrate. More preferably, this composition comprising a hierarchical cellular mesoporous metal-oxide is in the form of a film, spanning structure, or a hollow structure.

In another embodiment of this invention, a composition comprising a hierarchical cellular mesoporous metal-oxide is provided wherein said hierarchical cellular mesoporous metal-oxide is in the form of a planar hierarchical structure is provided. Preferably, this composition comprises wherein said planar hierarchical structure is on a ITO/glass substrate. More preferably, this composition comprising a hierarchical cellular mesoporous metal-oxide is in the form of a film, spanning structure, or a hollow structure.

Another embodiment of this invention provides a method of making a hierarchical cellular mesoporous metal oxide composition comprising providing a metal-organic/metal oxide aqueous phase, providing a silver-ion rich oil phase, emulsifying said metal-organic/metal oxide aqueous phase and said silver ion rich oil phase to form an emulsified component, and incorporating gas bubbles into said emulsified component by subjecting said emulsified component to frothing to form a hierarchical cellular mesoporous metal oxide composition. Preferably this method comprises wherein said metal-organic/metal oxide aqueous phase is TALH:TiO₂.

In another embodiment of this invention, a method of making a hierarchical cellular mesoporous metal oxide composition is provided comprising providing a metal-organic/metal oxide aqueous phase, providing a silver acetate ethanol solution, adding triethanolamine to said silver acetate ethanol solution to form a triethanolamine silver acetate ethanol mixture, providing an oil phase, adding said triethanolamine silver acetate ethanol mixture to said oil phase to form an triethanolamine silver acetate ethanol oil phase component, evaporating said ethanol rom said triethanolamine silver acetate ethanol oil phase to form an ethanolamine silver acetate oil phase, and adding said metal-organic/metal oxide aqueous phase to said ethanolamine silver acetate oil phase to form an metal-organic/metal oxide phase dispersed in said oil phase to form a homogenized mixture of said metal-organic/metal oxide aqueous phase and said oil phase. Preferably, this method comprises wherein the metal-organic/metal oxide aqueous phase is TALH:TiO2.

In another embodiment of this invention, a method of making a hierarchical cellular mesoporous metal oxide composition is provided comprising providing a metal-organic/metal oxide aqueous phase, providing a silver precursor component solubilized in ethanol solution, mixing said silver precursor component solubilized in ethanol in a polyacrylic acid-xanthum gum solution to form a silver polyacrylic acid-xanthum gum mixture, and mixing said silver polyacrylic acid-xanthum gum mixture into said metal-organic/metal oxide aqueous phase to form said hierarchical cellular mesoporous metal oxide composition. Preferably, this method comprises wherein said metal-organic/metal oxide is TALH:TiO₂.

In another embodiment of this invention, a method of making a hierarchical cellular mesoporous metal oxide composition is provided comprising providing a metal-organic/metal oxide aqueous phase, providing a silver precursor component, mixing said silver precursor component in a polyacrylic acid-xanthum gum solution to form a silver polyacrylic-acid-xanthum gum mixture, and mixing said silver polyacrylic-xanthum gum mixture into said metal-organic/metal oxide aqueous phase to form a hierarchical cellular mesoporous oxide composition.

In another embodiment of this invention, a method of making a hierarchical cellular mesoporous metal oxide composition is provided comprising providing a metal-organic/metal oxide aqueous phase, providing a silver precursor component solubilized in ethanol solution using ammonium hydroxide, mixing said silver precursor component solubilized in ethanol in a polyacrylic acid-xanthum gum solution to form a silver polyacrylic-acid-xanthum gum mixture, and mixing said silver polyacrylic-xanthum gum mixture into said metal-organic/metal oxide aqueous phase to form a hierarchical cellular mesoporous oxide composition.

In another embodiment of this invention, a method of making an oil based hierarchical cellular mesoporous metal oxide composition is provided comprising providing an oil phase composition comprising at least one of stearic acid, polyoxoethylene sorbitan monostearate, and lanolin, providing a silver precursor component solubilized in ethanol solution, adding at least one of ethanolamine or triethanolamine, or both, to said silver precursor component solubilized in ethanol to form an ethanolamine or triethanolamine or ethanolamine/triethanolamine and silver precursor component ethanol mixture, evaporating said ethanol from said ethanolamine or triethanolamine or ethanolamine/triethanolamine and silver precursor component ethanol mixture to form an ethanolamine or triethanolamine or ethanolamine/triethanolamine and silver precursor component mixture, providing a TiO₂ and TAHL aqueous solution, adding polyacrylic acid to said TiO₂ and TAHL aqueous solution to form a polyacrylic acid TiO₂ and TAHL mixture, adding said polyacrylic acid TiO₂ and TAHL mixture to said oil phase composition at a temperature of about 70 degrees centigrade to produce a homogenized mixture, and incorporating gas bubbles into said homogenized mixture to form an oil based hierarchical cellular mesoporous metal oxide composition.

In another embodiment of this invention, a method of making an oil-free hierarchical cellular mesoporous metal oxide composition is provided comprising providing a TiO₂ and TAHL and deionized water aqueous solution, providing a polyacrylic acid and a xanthan gum aqueous solution, adding said polyacrylic acid and a xanthan gum aqueous solution to said TiO₂ and TAHL and deionized water aqueous solution to form a polyacrylic acid and a xanthan gum TiO₂ and TAHL and deionized water aqueous solution, and incorporating gas bubbles into said polyacrylic acid and xanthan gum TiO₂ and TAHL and deionized water aqueous solution to form an oil free based hierarchical cellular mesoporous metal oxide composition oil free hierarchical cellular mesoporous metal oxide composition.

In another embodiment of this invention, a method of making an oil-free silver decorated foam hierarchical cellular mesoporous metal oxide composition is provided comprising providing a TiO₂ and TAHL and deionized water aqueous solution, providing a polyacrylic acid and a xanthan gum aqueous solution, adding said polyacrylic acid and a xanthan gum aqueous solution to said TiO₂ and TAHL and deionized water aqueous solution to form a polyacrylic acid and a xanthan gum TiO₂ and TAHL and deionized water aqueous solution, providing a silver acetate solution, adding ethanol to said silver acetate solution by solubilizing said ethanol and silver acetate solution with the addition of ammonium hydroxide aqueous solution to form an ethanol silver acetate solution, and wherein the silver acetate:ammonium hydroxide ratio is 1:9 mol, adding said ethanol silver acetate solution to said polyacrylic acid and xanthum gum aqueous solution to form a homogenized ethanol silver acetate polyacrylic acid xanthum gum aqueous solution, adding said homogenized ethanol silver acetate polyacrylic acid xanthum gum aqueous solution to said TiO₂ and TAHL and deionized water aqueous solution to form an ethanol silver acetate polyacrylic acid xanthum gum TiO₂ and TAHL and deionized water aqueous solution, and incorporating gas bubbles into said ethanol silver acetate polyacrylic acid xanthum gum TiO₂ and TAHL and deionized water aqueous solution to form an oil free silver decorated foam hierarchical cellular mesoporous metal oxide composition.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. As the color drawings are being filed electronically via EFS-Web, only one set of the drawings is submitted.

FIG. 1 shows a schematic of a plain and decorated TiO₂-TALH foams systems processing route of this invention.

FIG. 2a shows the viscosity of representative TEA (no-Ag ●) and Ag-decorated TiO₂ ( [symbol] ) oil-based foam-ink of this invention.

FIG. 2b shows the viscosity of Ag-decorated TiO₂ ( [symbol] ) oil-based foam-ink, Xanthan Gum baseline (▪), and Xanthan Gum-based Ag-decorated TiO₂ (□) precursor inks. FIG. 2b shows the characterization of the viscosity of the XG-baseline (without Ag), and Ag-decorated XG formulation of this invention.

FIG. 3a shows an optical microscope image of the Ag-decorated TiO₂ sample from an oil-based formulation of this invention. Sample shown in FIG. 3a was doctor bladed.

FIG. 3b shows an optical microscope image of the Ag-decorated TiO₂ sample from a xanthan gum-based formulation of this invention. Sample shown in FIG. 3b was doctor bladed.

FIG. 3c shows an optical microscope image of Ag-decorated TiO₂ sample from a xanthan gum-based formulation of this invention. Sample shown in FIG. 3c was as scooped and allowed to relax as it dried.

FIG. 4 shows six different SEM images of the L75-S3-O22 Ag-decorated TiO₂ foam composites of this invention as treated at different temperature and UV light (λ=254 nm) conditions for 20 min.

FIG. 5 shows six different SEM images of the Xanthan gum-based Ag-decorated TiO₂ composites of this invention as treated at different temperature and UV light (λ=254 nm) conditions for 20 min.

FIG. 6 shows six different SEM images of the Xanthan gum-based TiO₂ baseline composites of this invention as treated at 150° C. and UV-light (λ=254 nm) for 20 min.

FIG. 7a shows XRD patterns of the L75-S3-O22 Ag—TiO₂ foam composites of this invention as treated at different temperature and UV light conditions.

FIG. 7b sets forth detailed XRD regions where the metallic Ag peak would show.

FIG. 8a shows XRD pattern of the xanthan gum based TiO₂ ink Ag-decorated.

FIG. 8b shows XRD pattern of a baseline xanthum gum TiO₂ ink (i.e. without Ag).

FIG. 8c shows XRD pattern of the xanthan gum based TiO₂ ink Ag-decorated having the detailed XRD regions where the metallic Ag peak would show.

FIG. 8d shows XRD pattern of the baseline xanthan gum based TiO₂ ink (i.e. without Ag) having the detailed regions where the metallic Ag peak would show.

FIG. 9 shows EDS point analysis and mapping of the oil-based Ag-decorated TiO₂ foam treated at 300° C. for 20 min.

FIG. 10 shows EDS point analysis and mapping of the xanthan gum-based Ag-decorated TiO₂ composite treated with UV-light (λ=254 nm) for 20 min.

FIG. 11 shows a photograph of the doctor bladed, from left to right, a Ag-decorated TiO₂ oil-based sample of this invention, a Ag-decorated TiO₂ xanthum gum based film of this invention, and a TiO₂ xanthum gum based film, respectively, each treated under different energy conditions.

FIG. 12a shows Tauc plots for the determination of the optical bandgap of the differently treated oil-based Ag—TiO₂ foams of this invention.

FIG. 12b shows normalized UV-Vis spectra of the differently treated oil-based Ag—TiO₂ foams of this invention.

FIG. 13a shows a Tauc plot for the determination of the optical bandgap of an XG-based Ag—TiO₂ film of this invention.

FIG. 13b shows a normalized UV-Vis spectra for a XG-based Ag—TiO₂ film of this invention, treated under different energy conditions.

FIG. 13c shows a Tauc plot for the determination of the optical bandgap of an XG-based TiO₂ film.

FIG. 13d shows a normalized UV-Vis spectra for a XG-based TiO₂ film, treated under different energy conditions.

FIG. 14a shows a TEM image of an oil-based 500° C. treated Ag—TiO₂ foam of this invention.

FIG. 14b shows a TEM image of an oil-based 500° C. treated Ag—TiO₂ foam of this invention.

FIG. 14c shows a TEM image of a xanthan gum-based Ag—TiO₂ composite of this invention treated at 300° C.

FIG. 14d shows a TEM image of a xanthan gum-based Ag—TiO₂ composite of this invention treated at 300° C.

FIG. 14e shows a TEM image of a xanthan gum-based Ag—TiO₂ composite of this invention treated at 300° C.

FIG. 14f shows a TEM image of a xanthan gum-based Ag—TiO₂ ink of this invention treated at 500° C.

FIG. 14g shows a TEM image of a xanthan gum-based Ag—TiO₂ ink of this invention treated at 500° C.

FIG. 15a shows a TEM image of the primary TiO₂ particles with a scale bar of 20 nm.

FIG. 15b shows a TEM image of the primary TiO₂ particles with a scale bar of 10 nm.

FIG. 16 shows X-ray photoelectron spectroscopy detailed peaks Ag 3d (top left), Ti 2p (top right), C1s (bottom left), and O1s (bottom right), for the oil-based Ag-decorated TiO₂ foam composites of this invention.

FIG. 17 shows X-ray photoelectron spectroscopy detailed peaks Ag 3d (top left), Ti 2p (top right), C 1s (bottom left), and O 1s (bottom right), for the xanthan gum-based Ag-decorated TiO₂ ink composites of this invention.

FIG. 18 shows an EDS map of the “as doctor bladed” oil-based Ag—TiO₂ foam of this invention.

FIG. 19 shows EDS map of the oil-based Ag—TiO₂ foam of this invention treated under UV-light (λ=254 nm) for 20 min.

FIG. 20 shows EDS map of the oil-based Ag—TiO₂ foam of this invention treated at 150° C. for 20 min.

FIG. 21 shows EDS map of the oil-based Ag—TiO₂ foam of this invention treated at 300° C. for 20 min.

FIG. 22 shows SEM image showing the points for EDS analysis of the “as doctor bladed” XG-based Ag—TiO₂ film of this invention.

FIG. 23 shows EDS point analysis quantitative information and elemental map of the XG-based Ag—TiO₂ film of this invention treated under UV-light (λ=254 nm) for 20 min.

FIG. 24 shows EDS quantitative information and elemental map of the XG-based Ag—TiO₂ film of this invention treated at 150° C. for 20 min.

FIG. 25 shows EDS elemental map of the XG-based Ag—TiO₂ film of this invention treated at 300° C. for 20 min.

FIG. 26a shows X-ray photoelectron survey spectra of the oil-based Ag—TiO₂ composites of this invention.

FIG. 26b shows X-ray photoelectron survey spectra of the xanthum gum-based Ag—TiO₂ composites of this invention.

FIG. 27 shows XPS detailed peaks for the Ag-decorated TiO₂ oil-based foams treated under different energy conditions.

FIG. 28 shows XPS detailed peaks for the Ag-decorated TiO₂ xanthan gum-based films treated under different energy conditions.

FIG. 29 shows X-ray photoelectron spectra for the TiO2 Aeroxide® primary particles, survey and detailed scans.

FIG. 30 shows shear stress dependence on the shear rate for the studied foams of this invention. L-S-O amounts are in vol %; (1:6) indicates the TALH:TiO₂ mol ratio.

FIG. 31 shows scanning electron microscope images of the macro-pores inner surfaces for the different foams systems of this invention.

FIG. 32a shows linearized methylene blue concentration change in time, undergoing heterogeneous photocatalytic degradation in the presence of the different TiO₂ foams under UV light exposure at λ=254 nm.

FIG. 32b shows photograph of cuvettes with degraded methylene blue solutions after 200 min of UV exposure.

FIG. 33a shows a Barrett-Joyner-Halenda (BJH) cumulative micro-pore area (left facing arrow) and micro-pore area distribution (right facing arrow) for the primary TiO₂ nanoparticles and foam systems of this invention. The amount of liquid-solid-oil (L-S-O) is in vol %.

FIG. 33b shows a Horvath-Kawazoe micro-pore volume (left facing arrow) and micro-pore volume distribution (right facing arrow), for the primary TiO₂ nanoparticles and foam systems of this invention. The amount of liquid-solid-oil (L-S-O) is in vol %.

### DETAILED DESCRIPTION OF THE INVENTION

Multiphase Materials Systems: Encapsulating Materials and Controlling the Nucleation of Ag on TiO₂ Hierarchical Mesoporous Structures

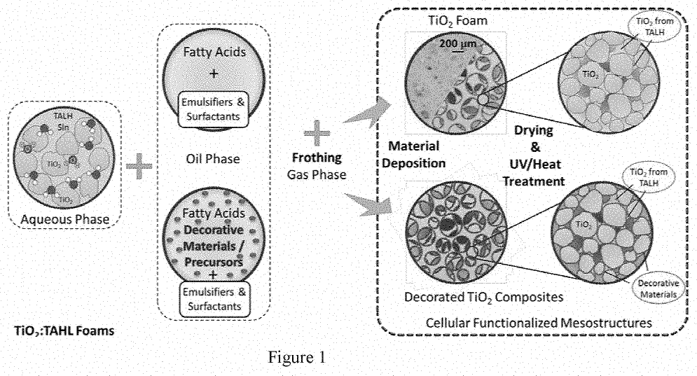

The previously studied Ti-organic/TiO₂ foam emulsion system¹, can be further used for the synthesis and selective positioning of a secondary phase material on the ceramic scaffold, to realize a hierarchically ordered mesoporous composite material such as a metal-ceramic composite, as depicted in FIG. 1.

The technology of the present invention is the process to make composite materials based on a metal-oxide and a decorating material, where the latter is encapsulated in a liquid phase complementary (different) to that metal-oxide (ceramic). The referenced material¹ M. A. Torres Arango, et al, ACS Sustain. Chem. Eng., 2017 acssuschemeng. 7b02450, serves as a preliminary study and foundation for the making the ceramic on its own (without any decorative/functionalizing features). In other words, the referenced material¹, discloses a method to make plain ceramic foams. In contrast, the present invention discloses the simultaneous synthesis of the decorative materials (of variable nature: metallic, metal-oxide, organic molecules, etc.) and the scaffold (metal-oxide) in the composites. Such a process of the present invention did not exist previously. Appendix I sets forth the background art technology of reference¹.

In one embodiment of the method of the present invention, the oil phase of an oil-in-water emulsion system is used to encapsulate a secondary phase material or their precursors, and induce their formation by using an external energy source or by using a chemical catalyst. Alternatively, in order to reduce the thermal budget associated to the composites' transformation from the emulsion state to the final functionalized ceramic, the use of hydrocolloids as foam stabilizers^{2,3}, and as secondary phase materials dispersion medium is disclosed. Food hydrocolloids, being widely studied and abundant rheology control compounds^{4,5}, highly compatible with living organisms, are great substitutional candidates for the realization of environment-friendly materials. Remarkably, the stabilization role of chitosan polysaccharide hydrocolloids has been reported previously for the fabrication of cellular Si-based soft materials⁶.

FIG. 1 shows the plain and decorated TiO₂-TALH foams systems processing route of this invention.

In the multiphase system of this invention, diverse composite groups are provided: metal-oxide/metal, metal-oxide/organic-molecule materials, metal-oxide/semi-metallic materials, and metal-oxide-I/metal-oxide-II composites. The former (i.e. metal-oxide/metal composites) are widely used for enhanced light harvesting applications including H₂ generation⁷⁻¹², small molecule detection¹³, catalysis^{7,9,14-22} and photovoltaics²³⁻²⁶ as well as for biomedical applications^{27,28} and antibacterial coatings²⁹. Metal-oxide/organic-molecule composites on the other side, are commonly used in optoelectronic systems such as dye-sensitized solar cells³⁰ and biocompatible systems such as scaffolds for tissue engineering³¹, and catalysts³². Other composites such as metal-oxide/semi-metallic materials find applications as catalysts and as sensor active layers³³, whereas multi metal-oxide composites find applications such as supercapacitors³⁴ and other energy related due to the important interface effects³⁵.

### 1. Design, Synthesis and Rheology Observations

To illustrate an embodiment of the method of the present invention, metal-oxide/metal composites (i.e. Ag-decorated TiO₂ foams) are synthesized. In the described method, the Ag decorations could be included as prepared particles dispersed within the phase complementary to the titania suspension, or they can be formed within such complementary phase from a solution including a Ag-precursor. The complementary phase (oil-based or hydrocolloid-based) serves as controlling agent of the secondary phase (decorative) material nucleation sites (i.e. the Ag particles will nucleate where the encapsulating phase reaches onto the metal-oxide structure), and to control the nucleation and growth rate (depending on the viscosity, pK_{□} properties, and thermal decomposition of such complementary phase). Nucleation of inorganic nanoparticles in oil-in-water emulsions has been demonstrated previously³⁶. However, its simultaneous synthesis, with that of mesostructured metal-oxide cellular architectures is herein provided for the first time. This method produces more complex ceramic composites.

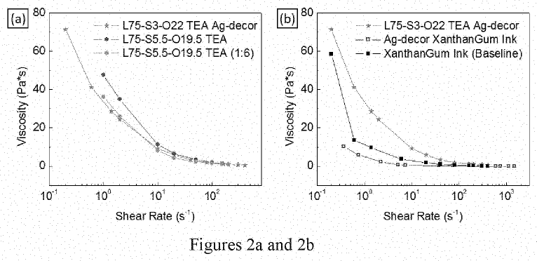

For the synthesis of Ag-decorated TiO₂ foam, the previously studied metal-organic/metal-oxide (TALH:TiO₂) suspension³⁷ and a Ag ion-rich oil phase are emulsified, and frothed to incorporate the gas bubbles that lead to macropore features. The only deviation from the plain TALH:TiO₂ foams synthesis procedure¹, is the triethanolamine (TEA) addition to the Ag acetate ethanol solution to induce the Ag-precursor solvation, instead of at the last mixing step before frothing. Once the Ag precursor is solubilized in ethanol, it is added to the oil phase. The ethanol solution mixes readily with the oil phase constituents at ˜70° C., and the blend remains clear and does not change its color. The Ag oil phase is stirred continuously to evaporate the ethanol, and once no volumetric changes are observed, the TiO₂ suspension is added and allowed to homogenize by continuous stirring while closed. Once the oil-phase and the titania suspension are visibly blended, frothing with a wisk-like mechanical mixer is performed. The viscosity of the decorated foam systems is comparable with the plain (non-decorated) foams as indicated by the dynamic viscosity measurements (see FIG. 2a).

For the hydrocolloid-based complementary phase, xanthan gum (XG) is used to reduce the amount of organic species used in the synthesis of Ag—TiO₂ structures, compared to the oil-based formulations. This formulation uses the same TALH:TiO₂ suspension as base, but instead of dispersing the Ag precursor in an oil-phase, it is mixed in the PAA-XG (polyacrylic acid-xanthum gum) solution and incorporated to the titania mixture. Since very small amounts of XG are required to significantly increase the viscosity of aqueous solutions³⁸⁻⁴⁰, a more efficient transformation of TALH into TiO₂ and the nucleation of the decorative secondary phase (Ag(0)) could be expected upon energy treatments such as UV or thermal-annealing. For this formulation, the Ag precursor was first solubilized in ethanol. A minimum amount of ammonium hydroxide was used to ensure its solvation. This solution was completely clear before mixing with the XG-PAA solution, upon mixing with such solution it became slightly turbid which is indicative of sedimentation/reduction of Ag in similar solutions⁴¹. Particularly, this reaction is characteristic of metallic Ag nucleation from a Tollens' reaction in contact with a polysaccharide compound like xanthan gum⁴². Then, the solution was immediately added to the TiO₂-TALH suspension and frothed as customary. The processing was performed in the dark to avoid uncontrolled light-induced changes of the ink.

FIG. 2a shows the viscosity of representative TEA (no-Ag ●) and Ag-decorated TiO₂ ( ★) oil-based foam-ink; and (b) Ag-decorated TiO₂ (★) oil-based foam-ink, Xanthan Gum baseline (▪), and Xanthan Gum-based Ag-decorated TiO₂ (□) precursor inks. Characterization of the viscosity of the XG-baseline (without Ag), and Ag-decorated XG formulation is presented in FIG. 2b. It can be observed that the obtained viscosity for the xanthan gum based formulations is significantly lower than that for the oil based foams. This in turn, results in the de-stabilization of the foam as it is sheared during the application to the substrates using doctor blading.

### Detailed Synthesis: Ag-Decorated TiO₂ Foam (Oil-Based)

To prepare the oil-based Ag-decorated foams, the oil phase constituents (stearic acid (SA), polyoxoethylene sorbitan monostearate (P60), and lanolin) are mixed and stirred until homogeneous at ˜70° C. (Centigrade). The Ag-acetate solution (Ag-acetate in ethanol, and the corresponding ethanolamine or triethanolamine) is added to this mixture and allowed to homogenize, afterwards the solvent is allowed to evaporate while stirring. In parallel, the TiO₂ particles and TAHL aqueous solution are mixed and sonicated, and the PAA is dropwise added to the TiO₂ mixture and further mixed and sonicated until becoming homogeneous. The latter, is dropwise added to the oil phase Ag-rich solution and complete homogenization is allowed at ˜70° C. Once homogeneous, the mixture is cooled down by stopping the heat while magnetically stirring. The air bubbles are then introduced with the aid of an electric wisk-like frother for ˜6-8 min. The Ag precursor added, is calculated to yield 1.2 wt % of metallic Ag from the total TiO₂—Ag final composite (i.e. excluding organic molecules).

TABLE 1
Ag-rich oil phase constituents.

| | | | | Molecular | Concen- |
|---|---|---|---|---|---|
| | | Chemical | | Weight | tration |
| Precursor | Function | Formula | Chemical Structure | (g/mol) | (wt %) |
| Stearic Acid (SA) | Oil phase constituent | CH₃(CH₂)₁₆COOH | 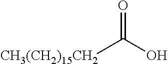 | 284.304 | 33.44 |
| Lanolin | Oil phase | — | — | — | 27.84 |
| | constituent | | | | |
| | Emulsifier | | | | |
| Poly- oxoethylene Sorbitan Monostearate (P60) | Oil phase constituent Surfactant Emulsifier | C₆₄H₁₂₆O₂₆ x + y + z + w = 20 | 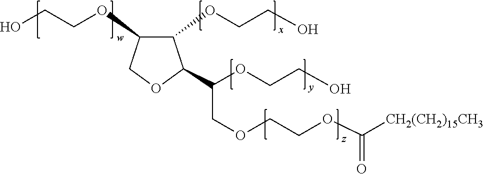 | 1311.046 | 33.39 |
| Ethanolamine (MEA) | Oil phase constituent | NH₂CH₂CH₂OH | 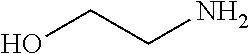 | 61.064 | 8.34 |
| Trieth- anolamine (TEA) | Surfactant Emulsifier | C₆H₁₅NO₃ | 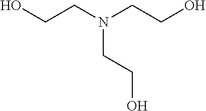 | 149.130 | |
| Ethanol | Solvent for Ag- precursor | CH₃CH₂OH | 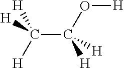 | 46.07 | 1 mL |
| Ag-acetate | Ag precursor | CH₃COOAg | 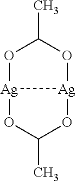 | 166.892 | 1.2 wt % (0.3 at %) of target TiO₂—Ag composite |

### Detailed Synthesis: Ag-Decorated XG TiO₂ Inks (Hydrocolloid-Based)

For the synthesis of the oil-free Ag-decorated foams, xanthan gum is used as viscosity enhancer. To prepare the inks, appropriate amounts of TiO₂ nanoparticles are mixed with TALH and DI water. The word “appropriate” amounts will be understood by those skilled in the art as a fitting description of the amount because depending on the ratios of TALH:TiO₂ foams with different surface area properties and pore interconnectivity may be realized as described in reference 1 of the reference section. For the specific example of the hydrocolloid-based route, the exact relative amounts used are disclosed in the concentration column of Table 2 in mol. (i.e. for this example for each 1 mol of TALH, 12 mol of TiO₂ are used). In the case of the oil based, the amounts are disclosed similarly in Table 1 (but in this case in wt %)—this because the lanolin does not have a standardized molecular weight that would allow us to make the calculations to relate everything in mol. Below is the complete composition of the oil-based ink in the example (aqueous and oil phases). The L:S:O (liquid-solid-oil) ratios and TiO₂:TALH ratios have important effects on the surface area properties and porosity as has been explained in reference 1 of the reference section. Their mention in the technical document intends to highlight the versatility of the composition in controlling these properties as has been demonstrated in such reference.

| Precursor | Weight (%) |
|---|---|
| TiO₂-particles | 9.63% |
| DI-water (all sources) | 65.09% |
| TALH (excluding water in precursor sln) | 2.95% |
| PAA | 0.72% |
| Stearic Acid | 5.71% |
| Polysorbate 60 | 6.27% |
| Triethanolamine—TEA | 1.57% |
| Lanolin | 5.22% |
| Ag-acetate (décor precursor) | 0.20% |
| Ethanol | 2.64% |

The mixture of TiO₂ nanoparticles, TALH and DI water is stirred for 15 min (minutes), and sonicated in a water/ice bath for 15 min to ensure thorough dispersion (while occasionally stirring to prevent sedimentation). In parallel a PAA-Xanthan gum (XG) aqueous solution is prepared and added dropwise to the titania mixture while stirring. The resulting mixture is sonicated for 15 minutes and set to stir for 15 more minutes before frothing. For the encapsulation of the Ag ions, Ag-acetate is mixed in ethanol and solubilized by adding ammonium hydroxide aqueous solution. The Ag-acetate:NH₄OH ratio is (1:9) in mol. This Ag-rich solution is added to the PAA-XG solution and allowed to homogenize before being added to the titania mixture. Aluminum foil is wrapped around all vials containing Ag to prevent light induced reactions or degradation. The inks are frothed for ˜8-20 min using a wisk-like attachment and a mechanical mixer to incorporate air bubbles. The Ag content is kept identical, and equivalent to 1.2 wt % of the final TiO₂—Ag composite.

TABLE 2
Ag-decorated XG TiO₂ inks constituents.

| | | | | Molecular | Concen- |
|---|---|---|---|---|---|
| Pre- | Func- | Chemical | | Weight | tration |
| cursor | tion | Formula | Chemical Structure | (g/mol) | (mol) |
| DI Water | Solvent | H₂O | 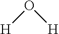 | 18.015 | 128.4 |
| Tita- nium bis (ammo- nium lactato) dihy- | Ti- organic (pre- cursor for TiO₂ bridg- | [CH₃CH(O—)CO₂NH₄]₂Ti(OH)₂ | 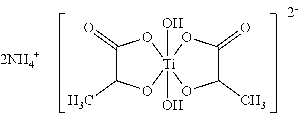 | 294.08 | 1 |
| droxide- | ing | | | | |
| TALH | struc- | | | | |
| | tures) | | | | |
| Tita- nium Dioxide | Pri- mary particles | TiO₂ | 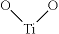 | 79.865 | 12 |
| Nano- | (target | | | | |
| particles | material | | | | |
| (20 nm | compo- | | | | |
| diam- | sition) | | | | |
| eter)- | | | | | |
| Aer- | | | | | |
| oxide ® | | | | | |
| Poly- acrylic Acid (PAA) | Adhe- sion pro- moting Nozzle- clog- | (C₃H₄O₂)ₙ | 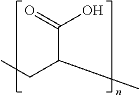 | 72.033 | 1 |
| | ging | | | | |
| | pre- | | | | |
| | venting | | | | |
| Xanthan Gum (XG) | Rheol- ogy en- hancer | (C₃₅H₄₉O₂₉)ₙ | 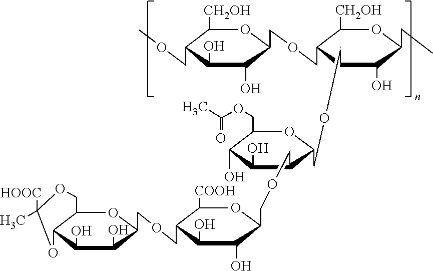 | 933.398 | 7.72 × 10⁻⁵ |
| Ethanol | Solvent for Ag pre- cursor | CH₃CH₂OH | 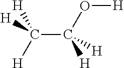 | 46.07 | 1.71 × 10⁻² |
| Ammo- nium Hydrox- ide | Solubi- lizing agent for Ag pre- cursor | NH₄OH | 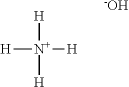 | 35.046 | 3.16 × 10⁻³ |
| Ag- acetate | Ag pre- cursor | CH₃COOAg | 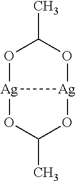 | 166.892 | 3.52 × 10⁻⁴ (1.2 wt % of target TiO₂—Ag composite) |

### 2. Microstructure

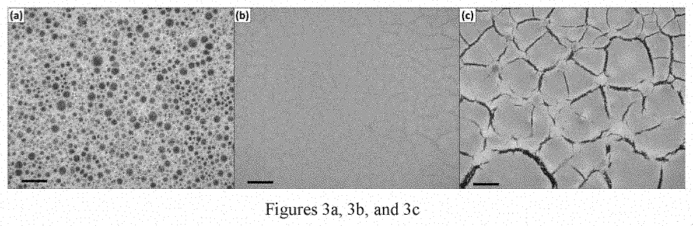

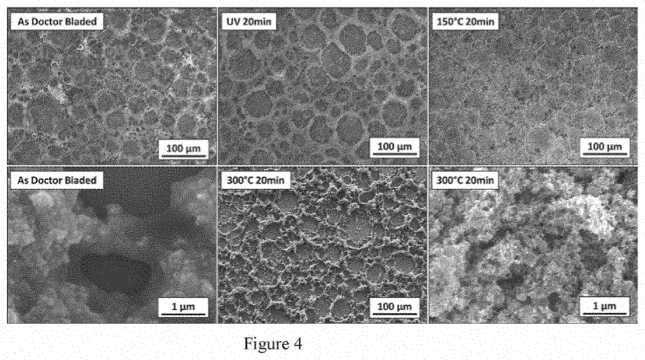

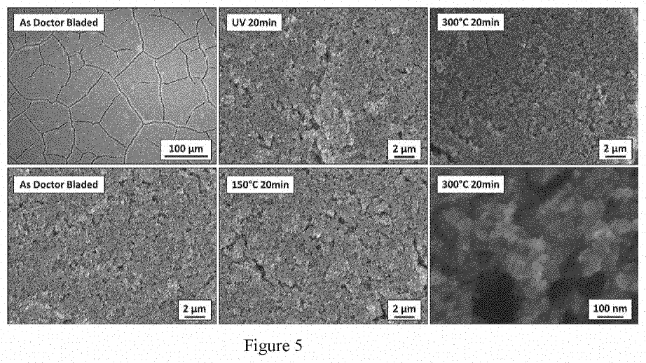

The difference in the morphology of the Ag-decorated composites (oil-based) and (XG-based) is apparent from the SEM and optical microscope images, where the foams stabilized using hydrocolloids rapidly allowed the solvent (water) to evaporate, resulting in the collapse of the gas macropores and the re-arrangement of the structure as films. See FIGS. 3a, b, and c, FIG. 4 and FIG. 5.

Ambient light exposure of the films results in their staining, indicative of reactive systems. The dried films are observed to be more stable to light exposure (against staining), than when exposed while wet; with the oil based foam system exhibiting the highest stability as observed from the optical microscope images. Such staining is observed to be blocked at the films' surface, as the collapsed pores of the XG-based Ag—TiO₂ non-sheared sample do not exhibit such staining, having collapsed while in the dark, after initial sample surface exposure to light (FIG. 3c). This drying/light exposure dynamics may be further investigated for their use in controlled photoreduction processes as drying causes the exposure of inner regions of the pores. This could be viewed as a “controlled healing” mechanism for the film cracks as drying progresses.

FIG. 3a shows the optical microscope images of the Ag-decorated TiO₂ samples from oil-based, and FIGS. 3b and 3c show xanthan gum-based formulations, respectively. Scale bars are 200 μm long. Samples (a) and (b) were doctor bladed; sample (c) as scooped and allowed to relax as it dried.

SEM images of the Ag-decorated TiO₂ foams are shown in FIG. 4. The broad porosity size distribution is apparent, featuring macropores as large as 80 μm and smaller features of ˜5 μm (from trapped gas). Additionally, meso- and micro-porous structures resulting from the aggregation of the primary particles and their micro-porous features are observed. From these images, the role of the oily-scaffold is once more elucidated—see FIG. 4 (high-magnification of “As Doctor Bladed” sample)—which shows that the oil phase serves as scaffold structure for the assembly of the titania suspension, maintaining the macropore structure as the solvent is evaporated during drying of the films.

FIG. 4 shows SEM images of the L75-S3-O22 Ag-decorated TiO₂ foam composites treated at different temperature and UV light (λ=254 nm) conditions for 20 min.

For the XG-based Ag—TiO₂ film, mud-cracking is observed (see FIG. 5), forming as the solvent evacuation progresses, due to relatively high localized tensile stresses⁴³. At this point, it becomes necessary to highlight the structural role of the oil phase which prevents the structure from cracking upon drying. However, during sintering, its cracking behavior will depend on additional aspects such as open- or closed-cell configurations, and relative L:S:O and TALH:TiO₂ ratios¹.

FIG. 5 shows SEM images of the Xanthan gum-based Ag-decorated TiO₂ composites treated at different temperature and UV light (λ=254 nm) conditions for 20 min.

Both XG-stabilized inks (Ag-decorated and baseline) result in similar film morphologies as observed from FIG. 5. The particle aggregation and mud cracking observed is characteristic of the TALH:TiO₂ ink systems³⁷.

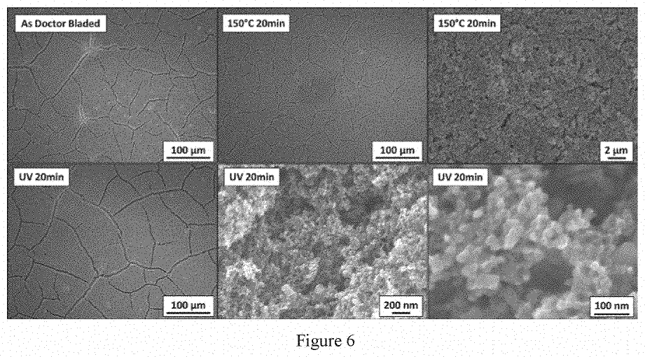

FIG. 6 shows SEM images of the xanthum gum based TiO₂ baseline composites, treated at 150° C. (Centigrade) and UV light (λ=254 nm) for 20 min.

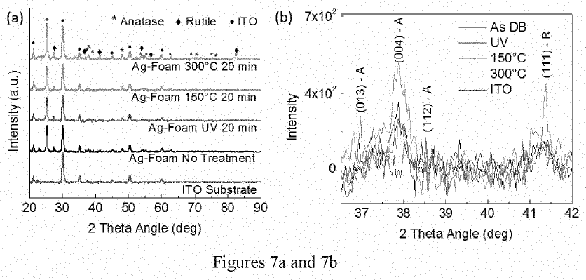

XRD patterns for the Ag-decorated TiO₂ oil-based foam (see FIGS. 7a and 7b), exhibit rutile and anatase phases as expected from the primary TiO₂ particles. The signal intensity is observed to be relatively similar to that of the ITO substrate, and is associated to the thin and porous character of the fabricated films, so that the collected signal resulted mainly from the substrate. Furthermore, from the XRD patterns, no clear evidence of Ag in metallic phase is obtained, which is mainly due to the low amount of Ag used for the decoration of the TiO₂ surfaces, ˜1.2 wt % (˜0.3 atomic %) of the total sintered composite (no remaining organic compounds); and to the small size of the formed Ag nanoparticles, with characteristic peaks significantly broader and lower in intensity when compared to those of TiO₂. Therefore, the peaks from metallic Ag may be confused with the background signal. Additionally, the diffraction peak with 100% relative intensity for metallic Ag should be located at ˜38.5° 20 angle, which may coincide with those for anatase at ˜38.01° and 38.84° (with expected larger intensity from the higher TiO₂ content), see FIG. 7b.

FIG. 7a shows XRD patterns of the L75-S3-O22 Ag—TiO₂ foam composites treated at different temperature and UV light conditions, and FIG. 7b shows detailed XRD regions where the metallic Ag peak would show.

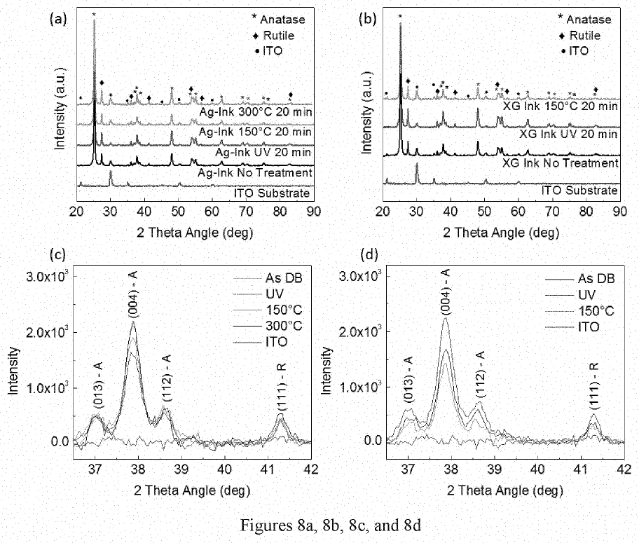

The XRD patterns for the XG-based inks (see FIGS. 6s 8a and 8b) show significantly higher intensity for the TiO₂ compared to the substrate signal, which is attributed to thicker films and more coverage of the substrate surface as can be inferred from the respective SEM images. Nevertheless, similarly to the Ag—TiO₂ oil-based foam, no conclusive evidence of Ag in metallic phase is observed from XRD, see FIGS. 6c and 8d. The Ag content is kept identical for both oil-based and XG-based Ag—TiO₂ composites.

FIG. 6a and FIG. 8c show XRD patterns of the xanthan gum based TiO₂ inks, FIGS. 8b and 8d show Ag-decorated and without Ag (baseline xanthan gum-TiO₂). FIG. 8c and FIG. 8d show detailed XRD regions where the metallic Ag peak would show.

EDS information for the Ag—TiO₂ composite systems were collected (see Appendix A, infra) and show gradual removal of the organic species as more energy is supplied in the post-processing treatments. Table 3 summarizes the different C:Ti and Ag:Ti atomic % ratios for the samples treated under such conditions. It is observed that almost no signal from Ag is obtained for the oil based samples, and may be explained by the small volume of sample (thin and porous); and the large amount of organics present, hindering the detection of Ag (in minimum concentration compared to the other elements detected). Nevertheless, Ag is detected for the 300° C.-20 min treatment, which significantly removes the organic species associated to the oil phase of the foam. The latter is evident from the C:Ti ratio, that decreases as more energy is provided. In contrast, the lower organics content in the XG Ag-decorated TiO₂ composites shows readily the Ag content even for the lower energy treatments, and exhibits a less pronounced decrease of the C:Ti ratio.

TABLE 3
C:Ti and Ag:Ti atomic % ratios from the EDS spectra for the
different energy treated Ag-decorated TiO₂ composites.

| EDS-Films | Treatment | C:Ti Ratio | Ag:Ti Ratio |
|---|---|---|---|
| Oil-based | As Doctor Bladed | 5.840 | 0.000 |
| Ag—TiO₂ Foam | 20 min UV | 6.503 | 0.000 |
| | 150° C. 20 min | 7.537 | 0.000 |
| | 300° C. 20 min | 1.828 | 0.010 |
| XG-based | As Doctor Bladed | 0.192 | 0.010 |
| Ag—TiO₂ Ink | 20 min UV | 0.147 | 0.016 |
| | 150° C. 20 min | 0.145 | 0.019 |
| | 300° C. 20 min | 0.175 | 0.010 |

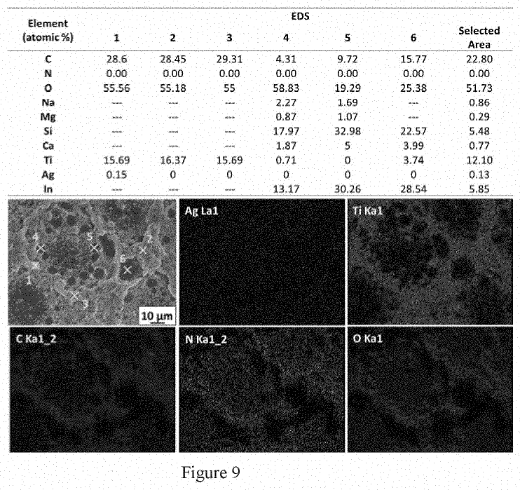

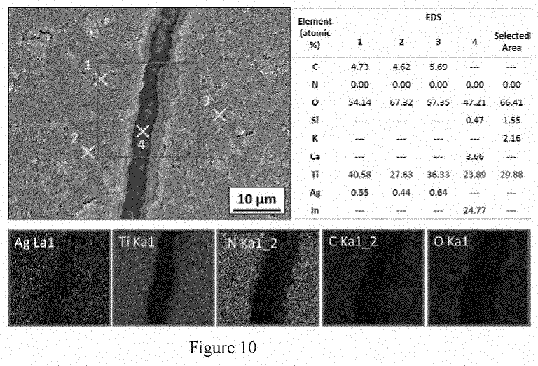

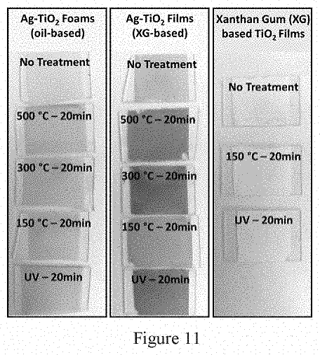

EDS mapping of the XG- and oil-based Ag—TiO₂ composites (see FIGS. 9 and 10), show uniform distribution of the Ag on the TiO₂, since no particularly high contrast spots of Ag are identified. The spectroscopic information from the mapped regions is labelled as “Selected Area” and is depicted in the magenta box (far right bottom box of FIG. 10) for the XG-based Ag—TiO₂ composite (FIG. 9). The selected area for the oil-based sample constitutes the entire imaged area in Figure. By design, the target compounds should only consist of Ti, 0 and Ag species. However, the utilization of organic precursor compounds and their incomplete removal is responsible for the C and N content, while all other species information originates from the substrate (ITO on glass). FIG. 9 shows EDS point analysis and mapping of the oil-based Ag-decorated TiO₂ foam treated at 300° C. for 20 min.

FIG. 10 shows EDS point analysis and mapping of the xanthan gum-based Ag-decorated TiO₂ composite treated with UV-light (λ=254 nm) for 20 min.

### 3. Opto-Electronic Properties and Microstructure

Despite the challenges encountered to obtain quantitative information about the Ag decorations from EDS and XRD (especially for the oil-based foam), the Ag—TiO₂ composites exhibit interesting coloration changes suggesting the presence of nanoparticles on the surface of TiO₂⁴⁴, see FIG. 71. FIG. 71 shows a photograph of the doctor bladed Ag-decorated TiO₂ samples treated under different energy conditions.

The optical bandgap of the studied samples, as calculated using the Tauc's relationship (eq. 1)⁴⁵, is observed to vary slightly according to the energy treatment administered, see Table 4. All the obtained values are characteristic of TiO₂ (3.1 eV-rutile; 3.3 eV anatase)⁴⁶. Tauc plots and UV-Vis spectra of the different Ag—TiO₂ oil-based and XG-based TiO₂ films are presented in FIG. 8 and FIG. 9, respectively. For the oil-based Ag—TiO₂ foams, a general increase in the E_{g} values is observed with increasing energy of the treatments. The lower energy treatments (i.e. UV and 150° C., for 20 min) exhibit E_{g} values closer to that of rutile TiO₂, and as the treatment temperature is increased, the obtained E_{g} values increase gradually to values close to that for anatase TiO₂. On the other hand, for the XG-based Ag-decorated TiO₂ films, the E_{g} values are observed to decrease systematically as the post-deposition energy treatments is increased. Also, the values for the plain (no Ag) TiO₂ XG-based films show E_{g} values with no significant variation.

TABLE 4
Optical band gap (E_{g}) of Ag-decorated TiO₂ composites, and
conduction band edge (E_{cb}) of decorating Ag particles.

| Sample | E_{g} (eV)* | □ ₘₐₓ | E_{cb} (eV)** |
|---|---|---|---|
| Ag—TiO₂ Foam As Doctor Bladed | 3.2000 | 453 | 2.7373 |
| Ag—TiO₂ Foam UV 20 min | 3.1205 | 440 | 2.8214 |
| Ag—TiO₂ Foam 150° C. 20 min | 3.1719 | 432 | 2.8704 |
| Ag—TiO₂ Foam 300° C. 20 min | 3.2103 | 437 | 2.8375 |
| Ag—TiO₂ Foam 500° C. 20 min | 3.2793 | 491 | 2.5255 |
| Ag—TiO₂ XG-Film As Doctor | 3.2760 | 456 | 2.7193 |
| Ag—TiO₂ XG-Film UV 20 min | 3.2603 | 440 | 2.8182 |
| Ag—TiO₂ XG-Film 150° C. 20 min | 3.2323 | 440 | 2.8182 |
| Ag—TiO₂ XG-Film 300° C. 20 min | 3.1290 | 469 | 2.6439 |
| Ag—TiO₂ XG-Film 500° C. 20 min | 3.1229 | 523 | 2.3709 |
| XG-based TiO₂ Film As Doctor | 3.2521 | — | — |
| XG-based TiO₂ Film UV 20 min | 3.2662 | — | — |
| XG-based TiO₂ Film 150° C. 20 min | 3.2790 | — | — |

*Calculated from Tauc plots (linear region extrapolation).
**Calculated using the Einstein's photon energy equation.

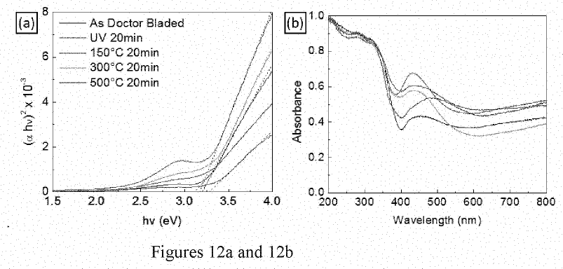

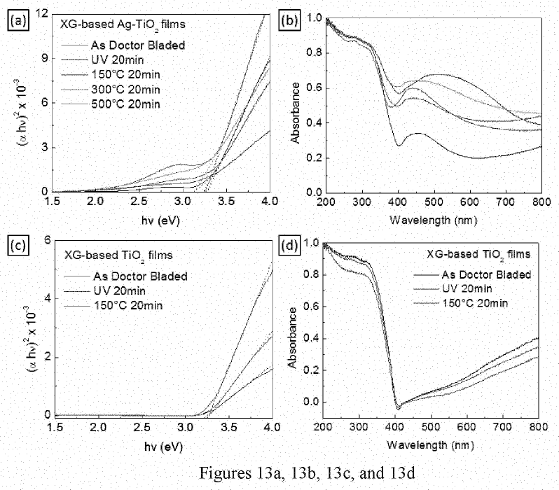

In the Tauc plots (FIG. 12a FIGS. 13a and 13c), the intercept of the line fitting the linear region of the end tail of the (αhv)² vs. hv with the abscissa⁴⁵, is used to determine the bandgap of the prepared samples.

(αhv)²=A(hν−E_{g})ⁿ (1)

Where n=½ for direct band gap semiconductors, A is a constant, hv is the photon energy, and □ is the absorption coefficient of the semiconductor. The latter in turn, can be calculated from Eq. 2, where k is the absorbance as measured using UV-Vis spectroscopy.

$$α = \frac{4 π k}{λ} \qquad ( 2 )$$

The conduction band energy (E_{cb}) of the decorating Ag nanoparticles has been calculated based on the UV-Vis information using the Einstein photon energy equation (Eq. 3) and is also included in Table 4.

$${E}_{cb} = \frac{hc}{{λ}_{max}} \qquad ( 3 )$$

Where h is the Plank constant, c is the speed of light, and λₘₐₓ the wavelength of maximum absorbance for the Ag peaks form the UV-Vis spectra. Our results for the E_{cb} of these nanoparticles are comparable with those obtained for spherical Ag nanoparticles of similar diameter⁴⁷. The Ag nanoparticles sizes for the representative Ag—TiO₂ composite systems have been determined from TEM as is discussed later in this application.

FIG. 82a shows Tauc plots for the determination of the optical bandgap, and FIG. 12b shows normalized UV-Vis spectra of the differently treated oil-based Ag—TiO₂ foams.

FIG. 93a shows Tauc plots for the determination of the optical bandgap—XG-based Ag—TiO₂ films, FIG. 13c shows—XG-based TiO₂ films; and normalized UV-Vis spectra, FIG. 13b shows—XG-based Ag—TiO₂ films, and FIG. 13d shows—XG-based TiO₂ films, treated under different energy conditions.

It is therefore of great interest to understand the nature of such changes in the E_{g}, since they may originate from localized effects of the Ag nanoparticles on the TiO₂ surface (also known as band edge bending)⁴⁸; as well as from the effect of the Ag nanoparticles on the crystallization of TiO₂ favoring the rutile phase formation at remarkably low temperatures^{49,50}. In these multiphase systems, where some of the TiO₂ is crystallizing from TAHL, the Ag nanoparticles may induce such crystallization to take the rutile phase instead of the anatase polymorph, as has been reported for TiO₂—Ag nanocomposites prepared from TiCl₄ using photodeposition and annealed at 600° C.⁴⁹. Typically, for the temperature ranges explored in this work (up to 500° C.), the crystallization of TALH into TiO₂ from suspension formulations without Ag, occurs in the anatase phase³⁷. However, the influence of the Ag nanoparticles (nucleating and growing in the proposed composite systems), may cause a deviation of such behavior. Such influence is expected to be significantly higher when using the XG-based Ag—TiO₂ formulations, than when using the oil-based Ag—TiO₂ route. The reason being, that in the oil-based Ag—TiO₂ foams, the nucleation and growth of the Ag nanoparticles is expected to be generally smaller than in the oil-free XG systems, for equivalent energy treatments, due to the lower viscosity of the XG-based formulations. Also, since less energy is required to decompose the added XG, than the oil phase used as gas stabilizer of the TiO₂-TALH aqueous suspension, the available energy is expected to nucleate the Ag nanoparticles more efficiently in the XG case. Additionally, since the Ag precursor is solubilized in an aqueous solution (for the XG case), the TiO₂ surfaces are readily available for the Ag ions to nucleate. In contrast, during the synthesis of the Ag—TiO₂ foams from the oil-based formulations, a significant amount of energy is used for the removal of the organics composing such phase (in which the Ag-precursor is solubilized). Therefore, for the Ag nanoparticles to induce the anatase to rutile phase transition, such particles would need to reach the sites where TALH is transforming. For such system (oil-based), the possible Ag nucleation sites are within the oil phase (where enough Ag⁺ ions cluster), and/or at the boundaries between the oil phase and the aqueous titania suspension. The latter being the preferred case as TiO₂ surfaces in the suspension would provide ordered nucleation sites, as well as photoreduction centers⁵¹ leading to Ag nuclei, in the case of the samples subjected to UV light treatments.

In order to confirm the nucleation of Ag nanoparticles from the investigated systems, representative samples, with presumably larger Ag nanoparticles were imaged using TEM.

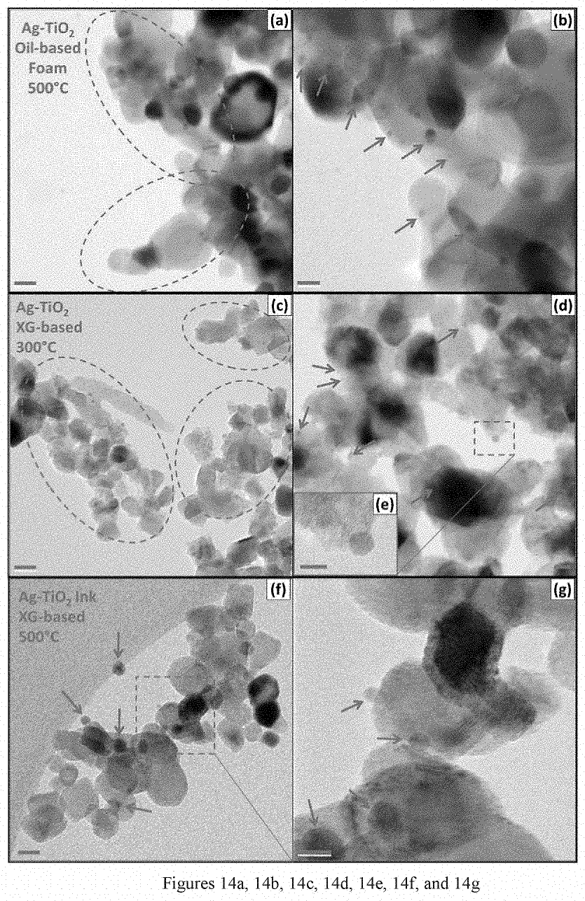

FIG. 10s 14a and 14 b show images of the Ag-decorated TiO₂ foams from the oil-based system treated at 500° C.; and from the xanthan gum-based system, treated at 300° C. (FIGS. 14c-14e, and 500° C. (FIGS. 14f and 14g). TEM imaging of the primary TiO₂ nanoparticles was also performed for comparison purposes.

In the TEM images of the Ag—TiO₂ composites, large TiO₂ formations can be distinguished. Scattered around such formations, smaller Ag nanoparticles are observed as highlighted with the dashed ovals and arrows. In contrast, the images taken from the primary TiO₂ particles, exhibit overall smaller and more uniform sized TiO₂ particles that aggregate forming clusters. The difference in particle aggregation for the latter, contrasting the Ag—TiO₂ systems can clearly be observed from FIGS. 14b, 14d and 14g, where the large TiO₂ formations show necking between neighboring TiO₂ particles; whereas FIG. 14b shows overlapping of primary TiO₂ particles. Additionally, the oil-based and XG-based Ag—TiO₂ composites show differences in the sample morphology at the nanoscale. For the oil-based system, a more continuous TiO₂ structure is observed when compared to the XG-based sample structures, regardless of the temperature conditions utilized. The latter result highlights the advantages of using immiscible phases for the dispersion of the decorating material precursor as in the case of the oil-based system, ensuring high connectivity of the metal-oxide scaffold.

The formed Ag particles, exhibit spherical shape with diameter sizes ranging from ˜2-4 nm for the 500° C. treated oil-based Ag—TiO₂ foams; and from ˜2-3 nm and ˜3-10 nm, for the XG-based Ag—TiO₂ composites treated at 300° C. and 500° C., respectively. Inset FIG. 14e shows one of the spherical Ag nanoparticles on the TiO₂ surface. Since the nucleated Ag particles are observed to grow when increasing the energy treatment from 300 to 500° C. (for the XG-based Ag—TiO₂ composites), it may be inferred that the size of the nucleated Ag particles for the samples treated using lower energy conditions exhibit smaller sizes.

The coloration of the samples, is indicative of different nanoparticle sizes. Also, the E_{cb} of metal nanoparticles is dependent on their size^{47,52,53}; thus, a correlation between the Ag-decorating nanofeatures and the calculated E_{cb} can be established.

FIGS. 104a and 14b show TEM images of the oil-based 500° C. treated Ag—TiO₂ foams, and FIGS. 14c, 14d, and 14e show xanthan gum-based Ag—TiO₂ composites treated at 300° C., and FIGS. 14f and 14g show treatment at 500° C. Scale bars are 20 nm for FIG. 14a, FIG. 14c and FIG. 14f; 10 nm for FIG. 14b, FIG. 14d, and FIGS. 14g; and 5 nm for FIG. 14e. Arrows indicate some of the Ag nanoparticles. Dashed ovals depict Ag nanoparticle rich areas. Dashed squares indicate enlarged regions in FIG. 14e, and FIG. 14g.

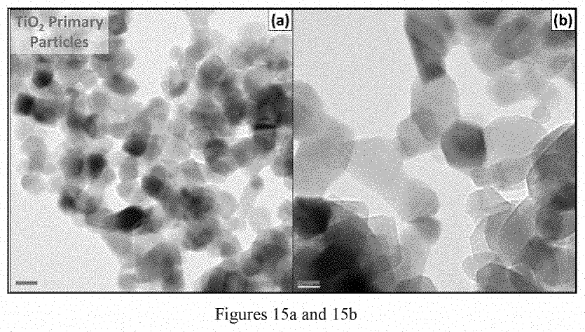

FIG. 15a and FIG. 15b show TEM images of the primary TiO₂ particles. Scale bars in FIG. 15a and FIG. 15) correspond to 20 and 10 nm, respectively.

### 4. Chemical State of Nucleated Secondary-Phase Nanoparticles

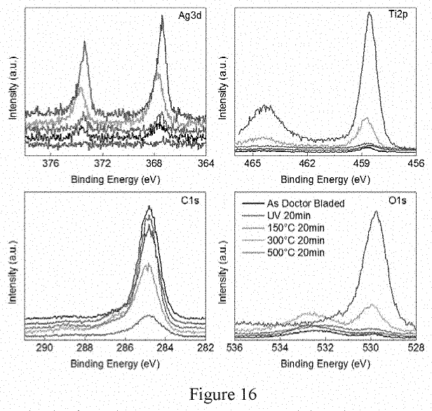

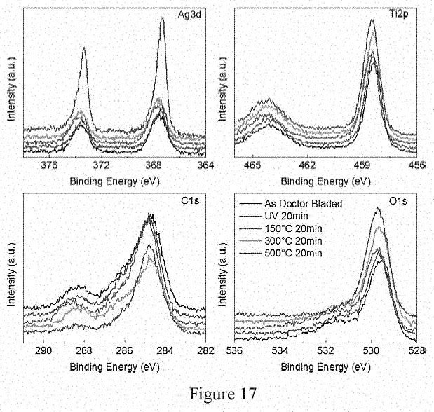

X-ray photoelectron spectroscopy (XPS) was used to investigate the oxidation state of the nucleated Ag nanoparticles and confirm their metallic state, as well as to assess the transformation of the samples with the respective energy treatments. For the oil-based Ag-decorated TiO₂ foam composites, the intensity of the Ag3d, Ti2p and O1s peaks is observed to increase as more energy is supplied, see FIG. 16. In contrast, the intensity of the C1s peak decreases as expected from the organics decomposition with increasing energy. Accordingly, the O band at ˜530 eV, corresponding to the Ti—O bond, is observed to increase at the expense of the O band at ˜532.5 eV, characteristic of the C—O bond.

FIG. 16 shows X-ray photoelectron spectroscopy detailed peaks Ag 3d, Ti 2p, C is and O 1s, for the oil-based Ag-decorated TiO₂ foam composites.

The XPS data collected for the XG-based Ag-decorated TiO₂ composites displays a general decrease of the C1s peak, which is associated to the organics removal with increasing energy (see FIG. 16). No significant peak shape change is observed for the O1s and C1s peaks, indicative of the reduced amount of organics in the XG-based formulation, when compared to the oil-based foams. Also, diminishing of the shoulder at ˜531.5 eV for the O1s peak can be observed as the temperature is increased. The intensity of the Ag3d peak for the 500° C. treated specimen, is significantly higher than that for the other samples; whereas the intensity for all the other peaks, is observed to be similar regardless of the energy treatment employed. These results agree with those from XRD and EDS, exhibiting stronger signal from the inorganic species for the XG thickened composites when compared to the oil-based counterparts.

Additionally, no significant shift is observed in the binding energy of the Ti2p peak, when comparing it to the spectra for the TiO₂:TALH system as shown in the XPS results of the previously studied TALH:TiO₂ system³⁷.

FIG. 117 shows X-ray photoelectron spectroscopy detailed peaks Ag 3d, Ti 2p, C is and O 1s, for the xanthan gum-based Ag-decorated TiO₂ ink composites.

Due to the incomplete removal of the organic species from the foams/inks studied when using low energy treatments (UV and 150° C.), it may be argued that the nucleated secondary phase materials correspond to mixtures of the Ag(0) with AgO, Ag₂O; and possibly Ag₂CO₃. Calculation of the modified Auger parameters (AP)⁵⁴⁻⁵⁶ from the XPS data, indicate values ˜726 eV (see Table 55), which are characteristic of the Ag(0), i.e. metallic Ag^{57,58}. Additionally, the non-significant change observed in the binding energy for the Ag3d_{5/2} peak among different energy treatments, can be taken as strong suggestion of the metallic character of the particles forming within the system.

TABLE 5
X-ray photoelectron spectroscopy binding energy and
modified Auger parameters AP for the Ag3d_{5/2}
peak from the Ag-decorated TiO₂ composites.

| Sample | Treatment | Binding | Kinetic | AP-3d_{5/2} | AP-3d_{5/2} |
|---|---|---|---|---|---|
| Oil-based | As Doctor | 367.67 | 351.60 | 726.27 | 719.27 |
| Ag—TiO₂ foams | UV 20 min | 367.60 | 351.60 | 726.20 | 719.20 |
| | 150° C. 20 min | 367.50 | 351.60 | 726.10 | 719.10 |
| | 300° C. 20 min | 367.76 | 351.60 | 726.36 | 719.36 |
| | 500° C. 20 min | 367.40 | 354.60 | 726.00 | 722.00 |
| XG-based | As Doctor | 367.60 | 351.60 | 726.20 | 719.20 |
| Ag—TiO₂ films | UV 20 min | 367.54 | 351.60 | 726.14 | 719.14 |
| | 150° C. 20 min | 367.77 | 351.60 | 726.37 | 719.37 |
| | 300° C. 20 min | 367.68 | 351.60 | 726.28 | 719.28 |
| | 500° C. 20 min | 367.42 | 353.60 | 726.02 | 721.02 |

Quantitative information on the XPS composition of the investigated samples is included in Table 6. The O:Ti ratio obtained is in all cases higher than 2 (the stoichiometric value for TiO₂); this ratio is observed to decrease as more energy is supplied to the oil-based Ag—TiO₂ foam systems, whereas it is kept relatively constant for the XG-based Ag—TiO₂ films. The Ag content is generally found to be higher than that measured from EDS (see Table 3). Because of the higher vacuum conditions met by the XPS equipment compared to the vacuum in the EDS instrument, the XPS values could be considered more accurate.

TABLE 6
Quantitative analysis of the sample composition, as calculated from the XPS peak fittings.

| | | Atomic % | | | | | | |
|---|---|---|---|---|---|---|---|---|
| Ink | Treatment | C | 0 | Ti | Ag | N | O:Ti | Ag:Ti |
| TiO₂ Aeroxide | (Primary | 30.4 | 51.0 | 18.5 | — | — | 2.76 | — |
| MTDF-03 | As Doctor | 91.1 | 6.56 | 0.90 | 0.1 | 1.3 | 7.29 | 0.12 |
| Oil-based | UV 20 min | 85.9 | 11.5 | 0.75 | 0.0 | 1.7 | 15.33 | 0.09 |
| Ag-decorated | 150° C. 20 min | 86.2 | 10.8 | 1.64 | 0.0 | 1.2 | 6.59 | 0.04 |
| | 300° C. 20 min | 68.3 | 25.9 | 4.84 | 0.3 | 0.5 | 5.36 | 0.08 |
| | 500° C. 20 min | 16.9 | 59.2 | 23.0 | 0.6 | 0.1 | 2.57 | 0.03 |
| MTDF-04 | As Doctor | 28.7 | 51.2 | 17.9 | 1.1 | 0.9 | 2.86 | 0.06 |
| Xanthan | UV 20 min | 29.2 | 49.5 | 18.5 | 1.1 | 1.4 | 2.67 | 0.06 |
| gum-based | 150° C. 20 min | 28.2 | 51.1 | 18.4 | 1.0 | 1.2 | 2.78 | 0.06 |
| | 300° C. 20 min | 23.7 | 52.7 | 21.7 | 0.7 | 0.9 | 2.42 | 0.03 |
| Ag- | 500° C. 20 min | 11.1 | 61.2 | 25.0 | 1.8 | 0.8 | 2.45 | 0.07 |

XPS survey and detailed scans for the different Ag—TiO₂ systems and the primary TiO₂ particles are included in Appendix A set forth below.

### Appendix A. Additional Characterization Data for the Ag-decorated TiO₂ Composites: EDS, XPS.

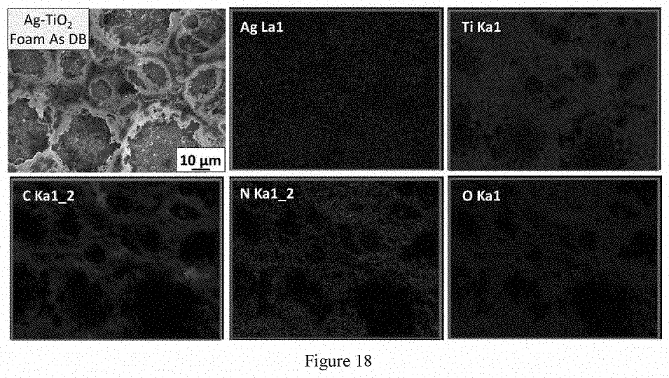

FIG. 18 shows EDS map of the “as doctor bladed” oil-based Ag—TiO₂ foam.

TABLE A 1
EDS quantitative information for the “as doctor bladed” oil-based Ag-TiO₂ foam.

| Element | (atomic %) | C | N | O | Na | Si | Ca | Ti | Ag | In |
|---|---|---|---|---|---|---|---|---|---|---|
| EDS | Selected | 59.45 | — | 26.58 | 0.22 | 2.2 | 0.36 | 8.06 | 0 | 3.14 |
| | Area | | | | | | | | | |

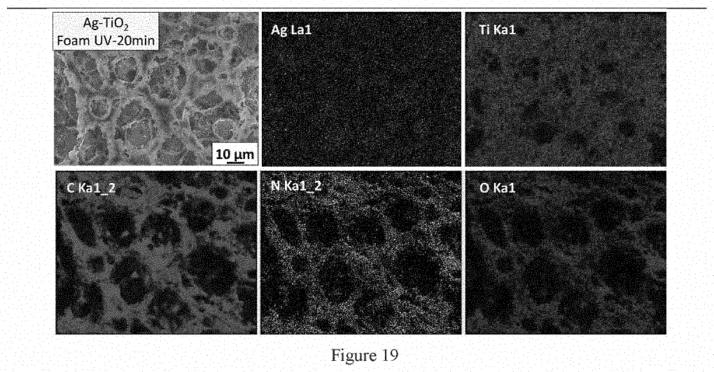

FIG. 19 shows EDS map of the oil-based Ag—TiO₂ foam treated under UV-light (λ=254 nm) for 20 min.

TABLE A 2
EDS quantitative information for the oil-based Ag-TiO₂ foam
treated under UV-light (λ = 254 nm) for 20 min.

| Element | (atomic %) | C | 0 | Na | Si | Ca | Ti | In |
|---|---|---|---|---|---|---|---|---|
| EDS | Selected | 62.04 | 25.32 | 0 | 1.05 | 0.22 | 9.54 | 1.84 |
| | Area | | | | | | | |

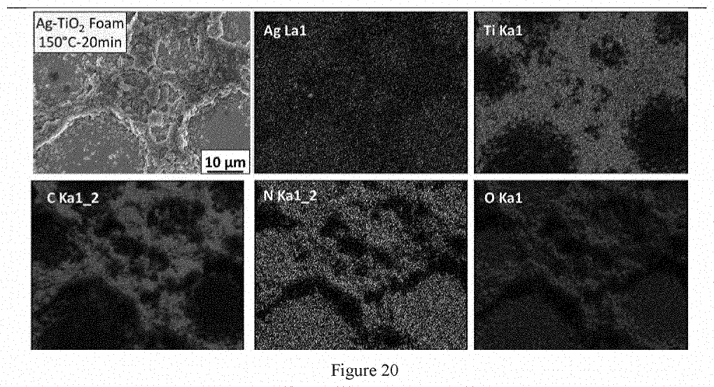

FIG. 20 shows EDS map of the oil-based Ag—TiO₂ foam treated at 150° C. for 20 min.

TABLE A 3
EDS quantitative information for the oil-based Ag-TiO₂ foam
treated at 150° C. for 20 min.

| Element | (atomic %) | C | 0 | Na | Si | Ca | Ti | In |
|---|---|---|---|---|---|---|---|---|
| EDS | Selected | 50.97 | 31.42 | 0.58 | 4.21 | 0.58 | 7.47 | 4.56 |
| | Area | | | | | | | |

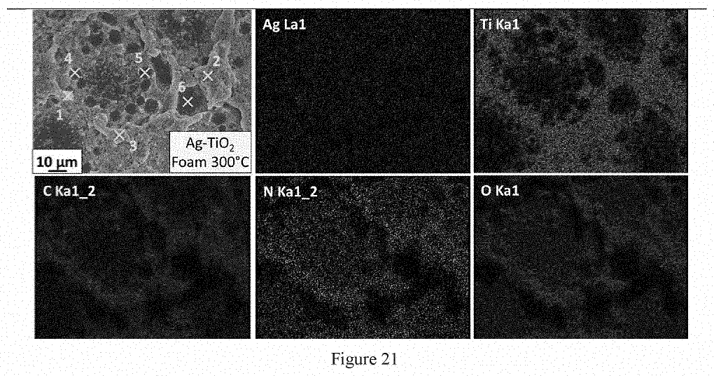

FIG. 21 shows EDS map of the oil-based Ag—TiO₂ foam treated at 300° C. for 20 min.

TABLE A 4
EDS quantitative information for the oil-based Ag-TiO₂ foam treated
at 300° C. for 20 min.

| Element | | | | | | | |
|---|---|---|---|---|---|---|---|
| (atomic | EDS | | | | | | |
| %) | 1 | 2 | 3 | 4 | 5 | 6 | Selected |
| C | 28.6 | 28.45 | 29.31 | 4.31 | 9.72 | 15.77 | 22.80 |
| N | 0.00 | 0.00 | 0.00 | 0.00 | 0.00 | 0.00 | 0.00 |
| O | 55.56 | 55.18 | 55 | 58.83 | 19.29 | 25.38 | 51.73 |
| Na | — | — | — | 2.27 | 1.69 | — | 0.86 |
| Mg | — | — | — | 0.87 | 1.07 | — | 0.29 |
| Si | — | — | — | 17.97 | 32.98 | 22.57 | 5.48 |
| Ca | — | — | — | 1.87 | 5 | 3.99 | 0.77 |
| Ti | 15.69 | 16.37 | 15.69 | 0.71 | 0 | 3.74 | 12.10 |
| Ag | 0.15 | 0 | 0 | 0 | 0 | 0 | 0.13 |
| In | — | — | — | 13.17 | 30.26 | 28.54 | 5.85 |

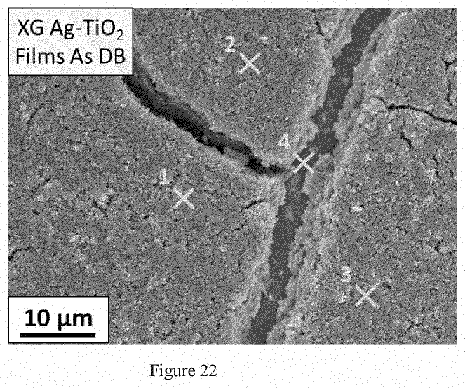

FIG. 22 shows SEM image showing the points for EDS analysis of the “as doctor bladed” XG-based Ag—TiO₂ film.

TABLE A 5
EDS quantitative information for the “as
doctor bladed” XG-based Ag—TiO₂ film.

| Element | EDS | | | |
|---|---|---|---|---|
| (atomic %) | 1 | 2 | 3 | 4 |
| C | 5.52 | 6.19 | 5.43 | 0 |
| N | 0 | — | — | 9.42 |
| O | 67.61 | 63.09 | 61.55 | 80.33 |
| Ti | 26.6 | 33.44 | 32.71 | 10.26 |
| Ag | 0.27 | 0.29 | 0.31 | 0 |

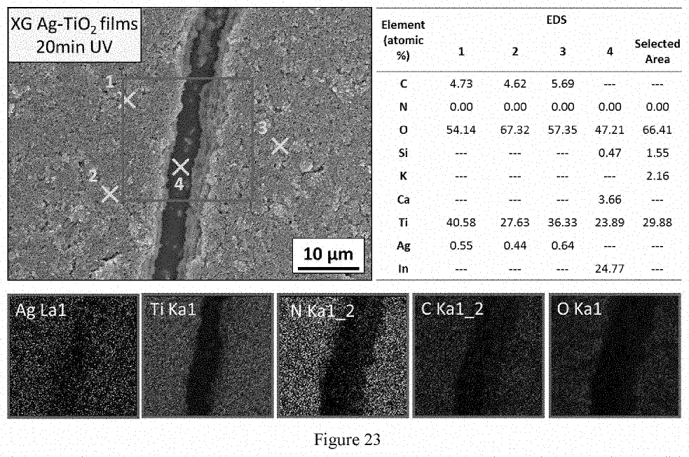

FIG. 23 shows EDS point analysis quantitative information and elemental map of the XG-based Ag—TiO₂ film treated under UV-light (λ=254 nm) for 20 min.

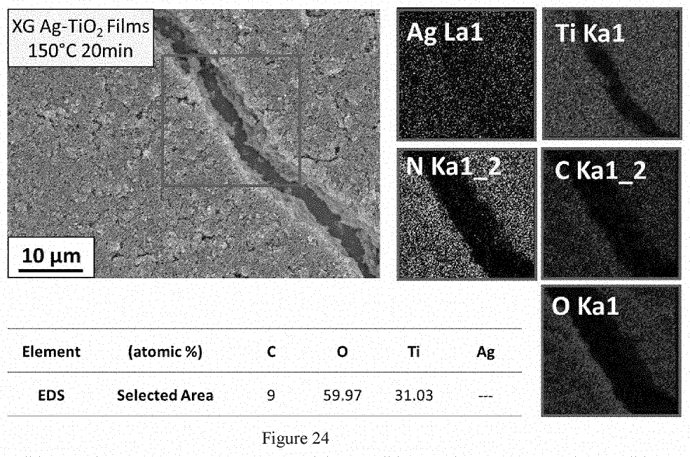

FIG. 24 shows EDS quantitative information and elemental map of the XG-based Ag—TiO₂ film treated at 150° C. for 20 min.

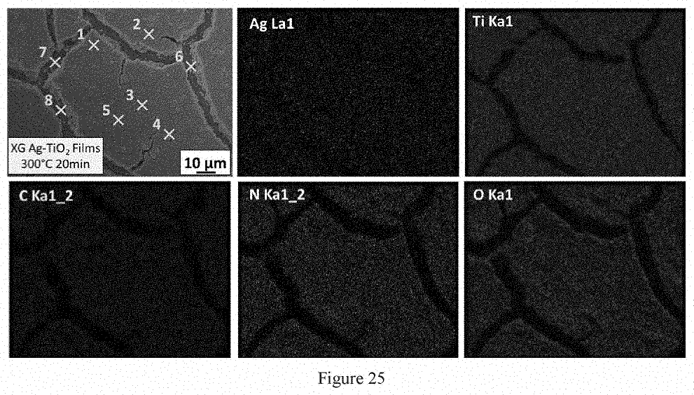

FIG. 25 shows EDS elemental map of the XG-based Ag—TiO₂ film treated at 300° C. for 20 min.

TABLE A 6
EDS quantitative information for the XG-based Ag-TiO₂ film
treated at 300° C. for 20 min.

| Element | EDS | | | | | | | | |
|---|---|---|---|---|---|---|---|---|---|
| (atomic %) | 1 | 2 | 3 | 4 | 5 | 6 | 7 | 8 | Selected |
| C | 4.77 | 5.19 | 5.58 | 6.34 | 6.03 | 5.7 | 4.34 | 3.9 | 7.96 |
| N | 0 | 0 | 0 | 0 | 0 | 0 | 0 | 0 | — |
| O | 62.82 | 71.19 | 68.72 | 72.54 | 67.69 | 65.44 | 35.26 | 39.12 | 61.36 |
| Si | — | — | — | — | — | — | 9.93 | 1.05 | — |
| Ca | — | — | — | — | — | — | 5.07 | 6.35 | — |
| Ti | 32.17 | 23.31 | 25.51 | 21.12 | 26.03 | 28.52 | 14.45 | 18.28 | 30.68 |
| Ag | 0.24 | 0.31 | 0.19 | 0 | 0.25 | 0.34 | 0 | 0 | — |
| In | — | — | — | — | — | — | 30.95 | 31.29 | — |

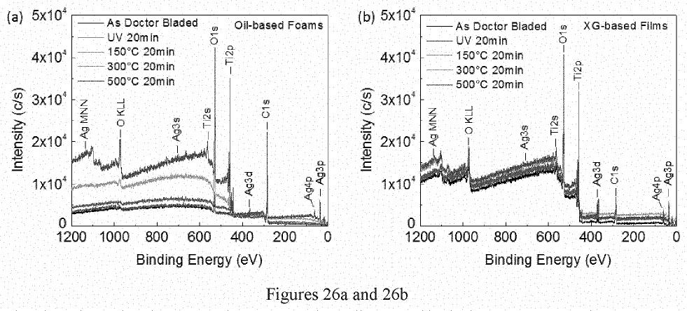

FIG. 26a shows X-ray photoelectron survey spectra of the Ag—TiO₂ composites from oil-based, and FIG. 26b shows X-ray photoelectron survey spectra of the Ag—TiO₂ composites from xanthan gum-based formulations of this invention.

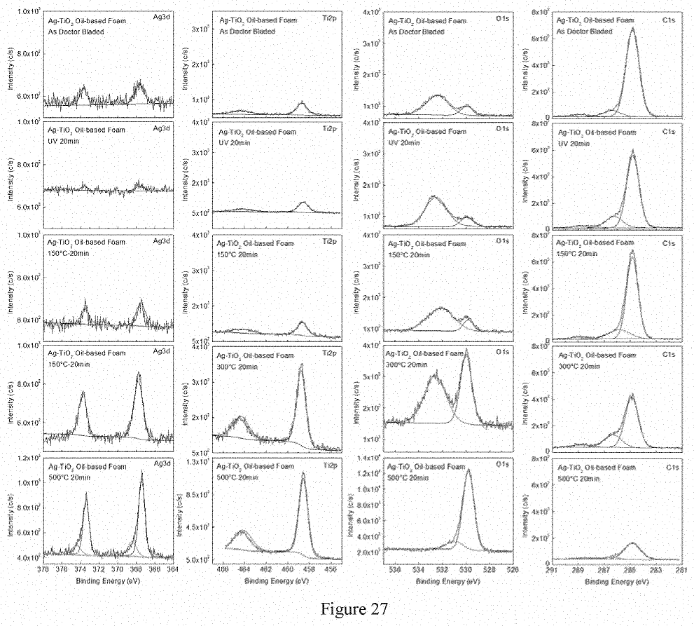

FIG. 27 shows XPS detailed peaks for the Ag-decorated TiO₂ oil-based foams treated under different energy conditions.

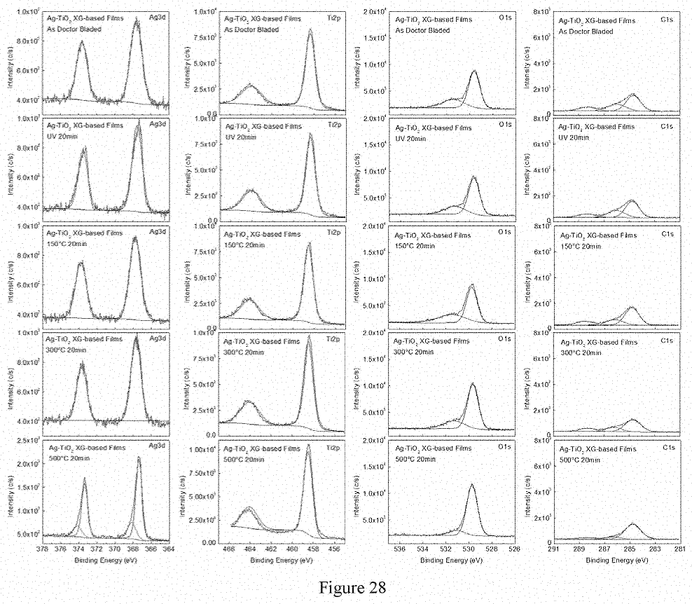

FIG. 28 shows XPS detailed peaks for the Ag-decorated TiO₂ xanthan gum-based films treated under different energy conditions.

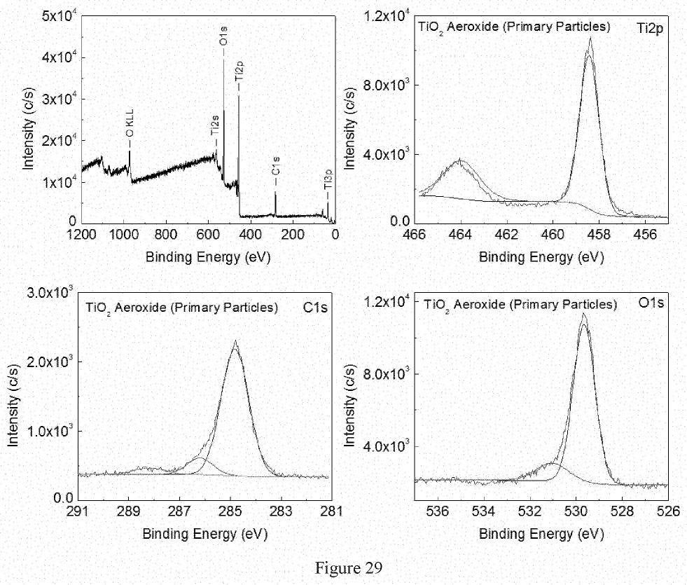

FIG. 29 shows X-ray photoelectron spectra for the TiO₂ Aeroxide® primary particles, survey and detailed scans.

In another embodiment of this invention, the method, as described herein, includes, for example, but not limited to, other metal-oxide/organic complex and decorative materials, and their combinations. For example, ZnO—Ag composites can be prepared, using zinc acetate in place of TALH(metal-organic precursor), ZnO nanoparticles in place of TiO2 nanoparticles (metal-oxide). In the same way, for example, but not limited to, the decorative material may consist of gold, or other metallic or semi-metallic nanoparticles.

Those persons skilled in the art understand that the present invention using the proposed and investigated multiphase emulsion material systems, secondary phase functionalizing features can be produced within the emulsion system, by dispersing/encapsulating their precursors in a complimentary phase of the emulsion and inducing their nucleation using energy treatments such as UV-light exposure or sintering. This method enables a novel, sustainable and relatively simple route, for the fabrication of hierarchically ordered cellular mesoporous ceramics with embedded functional nanofeatures. A distinction between the oil-based Ag—TiO₂ foams and the xanthan gum-based Ag—TiO₂ composites should be made, since the latter do not yield cellular macropore structures for the XG concentrations used in this invention. The xanthan gum concentrations utilized are relatively low thus not providing enough stabilization for the macropores (i.e. gas bubbles), since these are observed to collapse upon drying of the film and/or applied shearing stress. Characterization of the Ag—TiO₂ composites subjected to the different energy treatments was successfully done through XRD, EDS, SEM, XPS, UV-Vis spectroscopy and TEM. The nucleated nanoparticles are found to be in the metallic state as highlighted from the XPS results, and exhibit spherical shape with sizes below 10 nm. The distribution of the Ag nanoparticles is observed to be rather uniform on the TiO₂ surface. This investigation using Ag on TiO₂ structures, provides an alternative approach for the nucleation of secondary phase materials on metal-oxide structures with controllable microstructures, useful across multiple applications from energy to biomedical, including H₂ production though enhanced light-harvesting devices, photovoltaics, small molecule detection, catalyst, water cleaning and regeneration systems, and bio-compatible materials.

In one embodiment of this invention a composition comprising a hierarchical cellular mesoporous metal-oxide is provided. Preferably, this composition comprises wherein the hierarchical cellular mesoporous metal oxide is a metal organic/metal oxide.

In another embodiment of this invention, a composition comprising a hierarchical cellular mesoporous metal-oxide that is a metal organic/metal oxide that is TALH:TiO₂ is provided.

In another embodiment of this invention, a composition comprising a hierarchical cellular mesoporous metal-oxide is that is an Ag—TiO₂ xanthan gum based film is provided. Preferably, this composition comprises said hierarchical cellular mesoporous metal-oxide that is an Ag—TiO₂ oil based foam.

In another embodiment of this invention, a composition is provided comprising a hierarchical cellular mesoporous metal-oxide is the form of a three dimensional printed hierarchical based structure. Preferably, this composition comprises wherein said three dimensional structure is on a ITO/glass substrate. More preferably, this composition comprising a hierarchical cellular mesoporous metal-oxide is in the form of a film, spanning structure, or a hollow structure.

In another embodiment of this invention, a composition comprising a hierarchical cellular mesoporous metal-oxide is provided wherein said hierarchical cellular mesoporous metal-oxide is in the form of a planar hierarchical structure is provided. Preferably, this composition comprises wherein said planar hierarchical structure is on a ITO/glass substrate. More preferably, this composition comprising a hierarchical cellular mesoporous metal-oxide is in the form of a film, spanning structure, or a hollow structure.

Another embodiment of this invention provides a method of making a hierarchical cellular mesoporous metal oxide composition comprising providing a metal-organic/metal oxide aqueous phase, providing a silver-ion rich oil phase, emulsifying said metal-organic/metal oxide aqueous phase and said silver ion rich oil phase to form an emulsified component, and incorporating gas bubbles into said emulsified component by subjecting said emulsified component to frothing to form a hierarchical cellular mesoporous metal oxide composition. Preferably this method comprises wherein said metal-organic/metal oxide aqueous phase is TALH:TiO₂.

In another embodiment of this invention, a method of making a hierarchical cellular mesoporous metal oxide composition is provided comprising providing a metal-organic/metal oxide aqueous phase, providing a silver acetate ethanol solution, adding triethanolamine to said silver acetate ethanol solution to form a triethanolamine silver acetate ethanol mixture, providing an oil phase, adding said triethanolamine silver acetate ethanol mixture to said oil phase to form an triethanolamine silver acetate ethanol oil phase component, evaporating said ethanol rom said triethanolamine silver acetate ethanol oil phase to form an ethanolamine silver acetate oil phase, and adding said metal-organic/metal oxide aqueous phase to said ethanolamine silver acetate oil phase to form an metal-organic/metal oxide phase dispersed in said oil phase to form a homogenized mixture of said metal-organic/metal oxide aqueous phase and said oil phase. Preferably, this method comprises wherein the metal-organic/metal oxide aqueous phase is TALH:TiO2.

In another embodiment of this invention, a method of making a hierarchical cellular mesoporous metal oxide composition is provided comprising providing a metal-organic/metal oxide aqueous phase, providing a silver precursor component solubilized in ethanol solution, mixing said silver precursor component solubilized in ethanol in a polyacrylic acid-xanthum gum solution to form a silver polyacrylic acid-xanthum gum mixture, and mixing said silver polyacrylic acid-xanthum gum mixture into said metal-organic/metal oxide aqueous phase to form said hierarchical cellular mesoporous metal oxide composition. Preferably, this method comprises wherein said metal-organic/metal oxide is TALH:TiO₂.

In another embodiment of this invention, a method of making a hierarchical cellular mesoporous metal oxide composition is provided comprising providing a metal-organic/metal oxide aqueous phase, providing a silver precursor component, mixing said silver precursor component in a polyacrylic acid-xanthum gum solution to form a silver polyacrylic-acid-xanthum gum mixture, and mixing said silver polyacrylic-xanthum gum mixture into said metal-organic/metal oxide aqueous phase to form a hierarchical cellular mesoporous oxide composition.

In another embodiment of this invention, a method of making a hierarchical cellular mesoporous metal oxide composition is provided comprising providing a metal-organic/metal oxide aqueous phase, providing a silver precursor component solubilized in ethanol solution using ammonium hydroxide, mixing said silver precursor component solubilized in ethanol in a polyacrylic acid-xanthum gum solution to form a silver polyacrylic-acid-xanthum gum mixture, and mixing said silver polyacrylic-xanthum gum mixture into said metal-organic/metal oxide aqueous phase to form a hierarchical cellular mesoporous oxide composition.

In another embodiment of this invention, a method of making an oil based hierarchical cellular mesoporous metal oxide composition is provided comprising providing an oil phase composition comprising at least one of stearic acid, polyoxoethylene sorbitan monostearate, and lanolin, providing a silver precursor component solubilized in ethanol solution, adding at least one of ethanolamine or triethanolamine, or both, to said silver precursor component solubilized in ethanol to form an ethanolamine or triethanolamine or ethanolamine/triethanolamine and silver precursor component ethanol mixture, evaporating said ethanol from said ethanolamine or triethanolamine or ethanolamine/triethanolamine and silver precursor component ethanol mixture to form an ethanolamine or triethanolamine or ethanolamine/triethanolamine and silver precursor component mixture, providing a TiO₂ and TAHL aqueous solution, adding polyacrylic acid to said TiO₂ and TAHL aqueous solution to form a polyacrylic acid TiO₂ and TAHL mixture, adding said polyacrylic acid TiO₂ and TAHL mixture to said oil phase composition at a temperature of about 70 degrees centigrade to produce a homogenized mixture, and incorporating gas bubbles into said homogenized mixture to form an oil based hierarchical cellular mesoporous metal oxide composition.

In another embodiment of this invention, a method of making an oil-free hierarchical cellular mesoporous metal oxide composition is provided comprising providing a TiO₂ and TAHL and deionized water aqueous solution, providing a polyacrylic acid and a xanthan gum aqueous solution, adding said polyacrylic acid and a xanthan gum aqueous solution to said TiO₂ and TAHL and deionized water aqueous solution to form a polyacrylic acid and a xanthan gum TiO₂ and TAHL and deionized water aqueous solution, and incorporating gas bubbles into said polyacrylic acid and xanthan gum TiO₂ and TAHL and deionized water aqueous solution to form an oil free based hierarchical cellular mesoporous metal oxide composition oil free hierarchical cellular mesoporous metal oxide composition.

In another embodiment of this invention, a method of making an oil-free silver decorated foam hierarchical cellular mesoporous metal oxide composition is provided comprising providing a TiO₂ and TAHL and deionized water aqueous solution, providing a polyacrylic acid and a xanthan gum aqueous solution, adding said polyacrylic acid and a xanthan gum aqueous solution to said TiO₂ and TAHL and deionized water aqueous solution to form a polyacrylic acid and a xanthan gum TiO₂ and TAHL and deionized water aqueous solution, providing a silver acetate solution, adding ethanol to said silver acetate solution by solubilizing said ethanol and silver acetate solution with the addition of ammonium hydroxide aqueous solution to form an ethanol silver acetate solution, and wherein the silver acetate:ammonium hydroxide ratio is 1:9 mol, adding said ethanol silver acetate solution to said polyacrylic acid and xanthum gum aqueous solution to form a homogenized ethanol silver acetate polyacrylic acid xanthum gum aqueous solution, adding said homogenized ethanol silver acetate polyacrylic acid xanthum gum aqueous solution to said TiO₂ and TAHL and deionized water aqueous solution to form an ethanol silver acetate polyacrylic acid xanthum gum TiO₂ and TAHL and deionized water aqueous solution, and incorporating gas bubbles into said ethanol silver acetate polyacrylic acid xanthum gum TiO₂ and TAHL and deionized water aqueous solution to form an oil free silver decorated foam hierarchical cellular mesoporous metal oxide composition.

### Environment-Friendly Engineering & 3D Printing of TiO2 Hierarchical Mesoporous Cellular Architectures

3-D printing of hierarchically ordered cellular materials with tunable microstructures is a major challenge from both synthesis and scalable manufacturing perspectives. A simple, environment-friendly, and scalable concept to realize morphologically and microstructurally engineered cellular ceramics is herein demonstrated by combining direct foam writing with colloidal processing. These cellular structures are widely applicable across multiple technological fields including energy harvesting, waste management/water purification, and biomedical. Our concept marries sacrificial templating with direct foaming to synthesize multiscale porous TiO2 foams that can be 3D printed into planar, free-standing, and spanning hierarchical structures. The latter, being reported for the first time. We show how by varying the foam-inks' composition and frothing conditions, the rheological properties and foam configurations (i.e. open- or closed-cell) are tuned. Furthermore, our printing studies indicate a synergy between intermediate extrusion pressures and low speeds for realizing spanning features. Additionally, the dimensional changes associated to the post-processing of the different foam configurations are discussed. We investigate the effects of the foams' composition on their microstructure and surface area properties. Additionally, the foams' photocatalytic performance is correlated with their microstructure, improving for open-cell architectures. The proposed synthesis and scalable manufacturing method can be extended to fabricate similar structures from alternative ceramic foam systems, where control of the porosity and surface properties is crucial; demonstrating the great potential of our synthesis approach.

Ceramic based foams are highly desirable material systems because of their ability to mimic hierarchical organization widely existing in biological organisms⁵⁹. Such organization is beneficial in numerous applications from catalysis⁶⁰ to energy harvesting⁶¹ and storage⁶², to biomedical⁶³. Developments on the colloidal processing of such ceramics are of great interest because of the versatility that colloidal science brings to manufacturing. Currently, there is a burgeoning interest in the additive fabrication of foam-based hierarchical mesoporous structures. Despite the early studies demonstration of advantageous mechanical properties of Al₂O₃ structures^{64,65}, the employed synthesis methods utilize relatively large amounts of acid reagents to stabilize the particles and concomitantly gas bubbles forming the pores of the system, which represents challenges for their safe manipulation and large-scale implementation. Furthermore, such studies report exclusively closed-cell foam architectures, limiting the range of synthesized materials. Direct foaming is considered the most promising fabrication route for foam 3D printing (among the established synthesis methods: replica, sacrificial template and direct-foaming⁶⁶), because of the ability to control viscosity and prepare the foam as a patternable extrudate, while producing different microstructure and porosity configurations⁶⁷.

The present invention, emphasizes on the development of sustainable and relatively simple synthesis methods and formulations, to produce hierarchically ordered mesoporous cellular ceramics with tunable cell configurations (i.e. closed-/open-cell ceramic foams) and surface area properties. We investigate the design, synthesis, direct writing and post-processing of multi-phase TiO2-based wet-foams, controlling their morphology, microstructure and photocatalytic response. In particular our work addresses 8 of the 12 principles of green chemistry⁶⁸ for the developed materials and synthesis approach. Waste prevention is accomplished by incorporating additive manufacturing (i.e. 3D printing), since all the prepared foam batches can be printed in the exact amounts, geometries and substrate locations. The atom economy (AE) is estimated from our ink design calculations and thermogravimetric analysis (TGA). This synthesis method and resulting materials implement the less hazardous chemical synthesis principle, by involving non-toxic, renewable and bio-compatible ink precursors. The oil phase of the foams consists of fatty acids compounds commonly found in the cosmetic industry⁶⁹. Similarly, the use of ethanolamine and triethanolamine as emulsifiers is kept to minimum amounts, also comparable to those encountered in cosmetic products⁷⁰. In addition, the utilization of TALH as Ti-organic precursor, allows the formulation of aqueous based systems, exhibiting very slow hydrolyzation rates in neutral pH conditions⁷¹, hence avoiding the need to use organic solvents, and allowing ample time for their printing in ambient conditions. These considerations, make our ink system inherently safe and therefore transferable to industry. Finally, the synthesized foams could be recycled/regenerated⁷², and are generally safer than the primary TiO2 nanoparticles for applications such as water purification, being larger in size for easier recovery in case of accidental release to the environment.

We use TiO2 as a model system, having important applications due to its interesting semiconducting properties, tunable band gap, photocatalytic properties, bio-compatibility and abundance. Our approach represents clear progress in the fabrication of TiO2 foams, traditionally fabricated using laborious multi-step methods⁷³⁻⁷⁷. Some of the challenges of the conventional synthesis methods include the repetitive impregnation (or incorporation) and calcination removal of organic templates⁷⁶, or the time sensitive handling of rapid-hydrolyzing of liquid-liquid^{73,75}, and gas-liquid⁷⁴ emulsions systems. More recent methods, include the decomposition reaction of TiCl4 within aqueous-organic solvent mixtures, in which the pores are generated by HCl toxic fumes as a by-product of the hydrolysis of the Ti-precursor⁷⁷. Thus, our synthesis approach using abundant, water-compatible, non-toxic material precursors signifies a pivotal advance in the realization of hierarchically ordered mesoporous structures with applications ranging from photocatalysis^{76,78,79} to biomedical (as bone-scaffold structures⁸⁰) to opto-electronics^{81,82} and hydrogen production⁷⁷.

### EXPERIMENTAL

Foam Ink Synthesis and Characterization. The foam is prepared by mixing separately the aqueous and oil phases, then combining them and frothing the resulting emulsion to incorporate the air bubbles. For the aqueous phase, appropriate amounts of Ti(IV) bis(ammonium lactato) dihydroxide (TALH) (50 wt % in H₂O)—Sigma Aldrich, deionized (DI) water, and TiO₂ nanoparticles Aeroxide® P25 (70% Anatase, 30% Rutile)—Sigma Aldrich, were mixed and stirred for ˜15 min in a closed container. The mixture was then set in a sonication water/ice bath for 15 min to ensure thorough dispersion of the TiO2 particles while occasionally stirring to prevent sedimentation. After this, a polyacrylic acid (PAA)—Product #323667, Sigma Aldrich—solution in water (mixed beforehand) was dropwise added while stirring, and set for 15 min of sonication. Such solution consists of a DI water to PAA mole ratio of 20. The mixture was set to stir for at least 1 h (hour) before further mixing. The TALH:TiO₂ mole ratio was kept to 1:12 for all formulations (unless otherwise noted); the total TALH concentration was 0.15 and 0.3 M, for the L75-S3-O22 and L75-S5.5-O19.5 formulations, respectively. Also, the TALH:PAA ratio was kept equal to 1 for all experiments.

In parallel, stearic acid 97% (SA)—Acros Organics, polyoxoethylene sorbitan monostearate (P60)-Alfa Aesar, and lanolin-Sigma Aldrich where mixed in a closed container while heating at 80° C. constituting the oil phase. Once homogeneous, the aqueous phase was added to this oily mixture (dropwise while stirring), and rapidly closed to prevent solvent evaporation. The mixture was stirred at 350 rpm and allowed to homogenize. Then, ethanolamine (MEA)-Fisher Scientific, or triethanolamine 98% (TEA)-Alfa Aesar, was added and stirred for ˜30 seconds (enough time to be visibly blended). Finally, this mixture (oil phase+aqueous phase+MEA/TEA) was frothed with a wisk-like mechanical mixer HS583R Ovente, for 8 min. The ratio of the oil phase constituents (including the MEA or TEA) in weight % was (SA 33.44: P60 33.39: Lanolin 27.84: MEA/TEA 8.34); and the mole ratio of SA to TALH was 2 and 1 for the L75-S3-O22 and L75-S5.5-O19.5 formulations, respectively. The MEA or TEA were included as part of the oil phase, for the final liquid-solid-oil (L-S-O) volume ratio calculation purposes.

Apparent viscosity measurements of the foams were taken for foams frothed after 4 and 8 min, using a Brookfield DV-II+Pro rotational viscometer.

Foam Printing and Sintering. The foams were loaded into syringe-type cartridges and printed on ITO/glass substrates using a Nordson JR2300N robotic arm, equipped with a Performus V pneumatic pressure ink dispenser system. Different codes producing planar or 3-dimensional (3D) paths were used to fabricate films and spanning structures, and hollow column-like structures, respectively. The printing speed and extrusion pressure were varied from 2 to 15 mm/s, and from 2 to 30 kPa, respectively to study the printing space for these foam systems. The parameters chosen for printing the films used for photocatalysis were 8.2 kPa and 5 mm/s, covering an area of 2 cm2. For all the prints, SmoothFlow™ tapered plastic nozzles of 580 μm inner diameter were used at ˜500 μm dispensing height. After drying for approximately 30 min, the “green” foam printed structures were sintered at 500° C. for 30 min with a heating rate of 5° C./min and a cooling rate of 1° C./min, in a muffle furnace equipped with a SMART-3 fuzzy logic temperature controller Temp, Inc.®. Thermogravimetric analysis (TGA) of the foams was performed utilizing a TA Q500 analyzer, in air using a heating rate of 10° C./min.

### Hydrophobic Coating Substrate Treatment.

The hydrophobic sol-gel coating was prepared by using a variation of the method developed by Banerjee et al.⁸³ Briefly, tetraethoxysilane (TEOS), and perfluoropolyether-alkoxysilane (PFPE) in a mole ratio of 1:0.005 TEOS:PFPE were mixed until homogeneous. In parallel, a HCl aqueous solution (1:0.025 water:HCl mole ratio) was added dropwise to the TEOS-PFPE mixture while stirring. The solution was left under stirring for 24 h, after which ethanol was added to match a mole ratio of 1:3.75 water:ethanol. The substrates were dip-coated using a KSV Instruments dip-coater with a withdrawal speed of 50 mm/min and allowed to dry for approximately 30 min. Finally, the coated substrates were cured at 200° C. for 4 h with heating and cooling rates of 5° C./min.

Sintered Foam Characterization. X-ray diffraction (XRD) was performed with a PANalytical X'Pert Pro X-ray diffractometer with power settings of 45 kV and 40 mA. The data were analyzed with the aid of the X-Pert Highscore Plus PANalytical software. Optical microscope images were taken with a Dino Edge-Digital programmable optical microscope. Scanning electron microscopy (SEM) images were obtained using a Hitachi S-4700 SEM machine at 10 kV accelerating voltage and 15 mm working distance. Thickness measurements for the directly written foam films and 3D structures before and after sintering, were obtained though image analysis of optical micrographs using Image? software (NIH). Microporosity analysis (by monitoring nitrogen gas absorption) was performed with an ASAP2020 accelerated surface area and porosity system Micromeritics®; degassing of samples for microporosity measurements was performed using a Micromeritics vac-prep system for 24 hours (no heat) and 3 h at 110° C.

Photocatalytic Characterization. Heterogeneous photocatalysis degradation of a 10 μM methylene blue hydrate (MB)—Acros Organics—aqueous solution, was performed by placing the printed foam-films in identical beakers containing 20 ml of solution. A control solution was placed in identical conditions and labeled as “Blank”. The samples were left to stabilize for 30 min in the dark to allow for dye adsorption on the TiO2 prior to being exposed to UV light. UV irradiation at 254 nm wavelength was performed in a SpectroLINKER™ XL-1500 Spectroline® UV crosslinker chamber. The samples were positioned at ˜9.5 cm distance from the bulbs, with an average intensity of 6000 μW/cm².

Light absorbance of MB solutions was measured through UV-Visible spectroscopy using a JAZ UV-Vis spectrometer, OceanOptics. Solution aliquots were placed in polystyrene disposable cuvettes and analyzed every 20 min of continuous UV exposure. The spectra were recorded from 300 to 850 nm wavelength.

### Results and Discussion

This embodiment of this invention is a liquid-solid-gas foam-ink formulation, which is a hybrid synergistic strategy that combines the direct foaming and sacrificial template mechanisms, to produce porous structures with features in the micro-, meso- and macro pore range, using environment—friendly and abundant material precursors. The foam consists of crystalline TiO₂ nanoparticles in suspension with TALH as an organic Ti-precursor. The macro-pores of the foam structure are generated by frothing of the hybrid TALH/TiO₂ mixture, while stabilization of the gas phase is attained using an oil phase and surfactants. In these systems, additional stabilizing effects can be attributed to the TiO₂ particles, helping to maintain the trapped air bubbles, as is characteristic of multiple emulsion systems^{84,85}. Once the ink-foam is prepared, it can be shaped into the desired dimensions using continuous-flow direct writing and allowed to dry. The deposition of these foams through additive manufacturing, virtually eliminates any waste sources by printing the required structures' amount of material at specific substrate locations. Next, upon heat post-processing treatments, the TALH (in contact with the TiO₂ primary particles) is transformed into TiO₂ aiding the bridging between neighboring particles^{86,87} and providing mechanical and chemical stability to structures. Also, during such treatments, the organics, used as the emulsion surfactants and stabilization agents of the wet-foams, are removed leaving additional pores.

FIG. 1 shows the schematic synthesis route, and microstructure (photograph), of mesoporous TiO₂ foams. Being a multi-phase material system, there are significant interactions between the different foam constituents, resulting in complex relationships affecting the foams' morphology, microstructure, rheological properties, and surface and porosity properties to name a few. Thus, our foams' morphology can be tailored by varying their composition and frothing conditions, concomitantly affecting their viscosity and thus the printing parameters and space, i.e. planar vs. 3D structures.

When preparing the foams, their viscosity is observed to increase by one order of magnitude when the frothing time is increased from 4 to 8 minutes. In The apparent viscosity measured for foams with different liquid-solid-oil (L-S-O) phase ratios in vol %, indicates enhanced stability as the amount of oil phase is increased. These foams allow for more retention of gas (air) in the colloidal emulsion; in turn, resulting in larger viscosity values. The stabilization role of the oil phase, is attributed to the reduction of the gas-slurry surface tension and to the modification of their viscoelastic properties⁸⁸ (i.e. it provides the emulsion with yield-stress fluid properties). Similarly, the use of different surfactants (MEA vs. TEA), and TALH:TiO₂ ratio is also observed to modify the viscous properties of the foams.

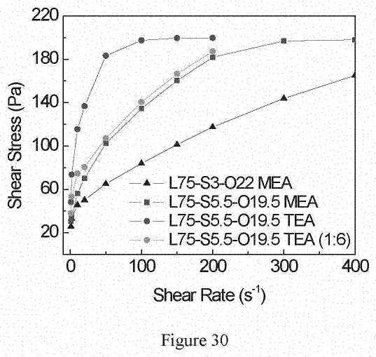

Viscosity of the TALH:TiO₂ 1:12 foams after 4 min and after 8 min frothing time, from different liquid-solid-oil content (vol %) formulations were obtained For paste-like fluids such as the ones obtained with our method, the Herschell-Bulkley model (see Equation 1), indicates shear-thinning flow regimes. Analysis of the shear stress—shear rate relationships of the foams gives Herschell-Bulkley coefficients as indicated in Table 1. The values of the flow index n, are characteristic of shear-thinning fluids being between 0 and 1. τ is the total shear stress and τ_{y} the fluid yield-stress; k denotes the fluid consistency⁸⁹. The shear stress dependence on shear rate is included as FIG. 30.

τ=τ_{y}±kγ^{.n} (1)

TABLE 1
Herschell-Bulkley coefficients for the 8 min frothed foams.

| Foam Ink* | τ_{y} | k | n |
|---|---|---|---|
| L75-S3-O22 MEA | 41.5050 | 0.5528 | 0.9241 |
| L75-S5.5-O19.5 MEA | 62.9610 | 0.6741 | 0.9503 |
| L75-S5.5-O19.5 TEA | 100.9900 | 9.5214 | 0.6232 |
| L75-S5.5-O19.5 TEA (1:6) | 59.5970 | 2.5206 | 0.7454 |

*Amount of liquid-solid-oil (L-S-O) in vol %;
(1:6) refers to TALH:TiO₂ mole ratio.

Foam flow exhibits both solid-like and liquid-like behavior. In particular, one observes a yield stress τ_{y}; the value of the yield stress is also related to the foam's morphology, especially for dry foams⁹⁰. The value of the yield stress typically decreases as the liquid volume fraction increases. For our foams systems, this can be observed in the lower shear-stress values for the foams with lower TiO₂ primary particles content. However, it is observed that the type of surfactant used (i.e., MEA or TEA) also affects the foams' rheology. Other aspects of solid-like behavior are a finite shear modulus and slip at solid surfaces. Liquid-like aspects are a shear-thinning viscosity and time-dependent properties. Unless stabilized, the bubbles can collapse, reducing the volume of the initially frothed system as time elapses⁹⁰. The compressibility of the foams is also an important factor that influences its rheology and is mostly responsible for the foam's elastic properties upon compression stress application—such as that exerted during CDW. Theories of foam flow predict that, in shear flow, foam viscosity η is generally given by:

η=τ_{γ_}/γ^{.}+ηₚ (2)

In which γ^{.} is the shear rate and ηₚ is the plastic viscosity. The latter quantity arises due to dissipation in the liquid film, and its value is proportional to the viscosity of the liquid phase. This term is significant only for wet foams or those formulated with extremely viscous liquids. The first term on the right of the above equation represents the elastic component, and its value increases as the gas volume fraction is increased⁹⁰.

Using our foam-ink system in combination with continuous-flow direct writing (CDW), the fabrication of planar and 3D free-standing and spanning foam structures is investigated. CDW employs a PC-controlled translation stage that moves relative to a device (i.e. a dispensing nozzle) to pattern the ink⁹¹. This method has been introduced a few years ago⁹² and has recently re-emerged due to its inherent ability to extrude a wide range of viscosities⁹³ thus enabling significant ink design freedom and fabrication of planar and 3D film/pattern architectures⁹⁴ with resolution comparable to inkjet printing. This TiO₂-water compatible system is desirable since it restricts the use of organic solvents thus promoting sustainable and scalable manufacturing. Moreover, from our preliminary studies we observe that the rapid hydrolysis of emulsions using non-aqueous Ti n-alkoxides as the organic precursor, typically used in TiO₂ nanomaterials synthesis⁹⁵ inhibit the printing of emulsions due to clogging of the dispensing nozzles.

We carried out printing of planar and 3D TiO2 foams, including spanning structures for a distance up to 5 mm. These structures are observed to retain their shape, while they slightly adhere to the hydrophilic glass edges. Printing of spanning structures on hydrophilic and pre-treated substrates with hydrophobic coatings show a difference on their substrate-wetting, being greater for hydrophilic substrates. This difference is expected because of the large amount of aqueous phase in the foam formulation, and proves useful for controlling the ink/substrate interactions. Despite of the surface treatment, adhesion of the foams to the substrates was favorable, which we attribute to the amphiphilic nature of the foam. Generally, for CDW, the ink formulations should display shear-thinning behavior that allows for the printed structures to be formed, and retain their shape once printed. The extrapolated yield stress for the investigated foam systems ranging from ˜40 to 100 Pa, allows for their extrusion and shaping at relatively low pressures. Our values (summarized Table 1), are comparable to those obtained for systems used to fabricate mullite spanning structures⁹⁶ and lay around the lower limit of those reported as necessary for inks to withstand their own weight across a spanning distance without collapsing, typically ranging from 1 to 1000 Pa.1⁹⁶⁻⁹⁹. The values reported here are viewed with respect to the differences between the foam system used in our work and those reported for gel systems⁹⁸ as well as the foam nature of our ink system being significantly different from a degassed slurry. In addition, we 3D printed hollow columns and investigated their dimensional changes before and after sintering.

We observed the printing space for the investigated TiO2 foam systems using 580 μm nozzles inner diameter at 500 μm dispensing height. We printed 3-dimensional layered hollow columns, 3-dimensional layered, and spanning foam structures, at 9.6 kPa and 5 mm/s on hydrophobically treated glass. Scale bars at 1 mm long.

When using CDW to print these foam systems, we find that the main printing parameters that affect the printing fidelity are speed and pressure (for a given dispensing nozzle size and dispensing height). In the printing space, we observe three main regions, including overflow at relatively high dispensing pressures and lower speeds, due to the high volumetric flow rate of the foams. The second regime, the printable region, is confined between ˜6 kPa and ˜20 to 28 kPa of dispensing pressure. Finally, a poor-edge definition region is found at pressures below ˜6 kPa, where the fidelity of the printing is compromised yielding wavy-shape features due to inconsistent flow and dimensional filament changes. In the printable region, at lower speeds (i.e. ˜1-7 mm/s), spanning structures can be fabricated while maintaining the dispensing pressure at intermediate levels. The latter may be attributed to the extrudate being structurally coherent and stressed to a relatively small extent at such speed range. At higher speeds, the extrudate is elongated enough for the gas and oil phases to significantly deform and eventually collapse. However, foam printing of planar structures can be performed for a significantly wider range of printing conditions. In addition, it is found that the printing resolution (i.e. line width) generally increases as speed is increasing and pressure is decreasing within the planar printing regime. The resolution of the printed features is typically improved up to a nozzle diameter in width.

We have identified different means of control of the foams' pore size, configuration (as open- or closed-cell), and surface area properties; via emulsions' composition. The amounts of solids (TiO₂ primary particles) and solvent in the foams affect their viscosity, and therefore the mobility of the emulsion's liquid phase as the frothing progresses. This is yielding open-cell foam structures as the solvent amount is increased with respect to the amount of TiO₂ primary particles, i.e. larger L:S ratio; and conversely closed-cell foams as this ratio is decreased. Similarly, the use of MEA or TEA as surfactants, with different viscosities and pKₐ properties, affects the foam's viscosity and mobility, resulting in slightly different foam microstructures. For the same L:S ratio, when using MEA, slightly larger macropores can be distinguished when compared to TEA. We investigate both TEA and MEA, since TEA is aiding towards higher ink viscosities, which are desired for 3D printing. In addition, it is observed that the larger macro-pores—corresponding to trapped air bubbles—are larger in size for the foams with lower TiO₂ primary solids, suggesting that such formation is strongly influenced by the particle aggregation behavior, observed in our previous studies of the aqueous phase of the foam⁸⁶. Specifically, it is postulated that the TiO₂ nanoparticles tend to aggregate at the periphery of the gas bubbles, and when high in concentration, lead to macro-pore size suppression as the solvent is evacuated. Similar relationships between viscosity and foam pore size distribution have been reported for pH-particle stabilized Al₂O₃ foam systems^{8, 100, 101}. The foam from the (1:6) TALH:TiO₂ ratio aqueous suspension, is leading also rather open-cell configurations, strengthening the latter observation since there is more Ti-organic with respect to TiO₂ primary particles, and therefore the inter-particle interactions are affected.

We performed low-magnification optical microscope and SEM images of the open-cell foam of this invention, and low-magnification optical microscope and SEM images of closed-cell foams of this invention. Scale bars corresponded to 200 μm for optical microscope images, and to 100 μm for SEM images. Thermo-gravimetric analysis profiles for the different foam formulation were performed as discussed infra.

The formation of a crust in the printed foams, common to all foams prepared, exhibits smaller pore sizes when compared to the inner regions of the foams. Such crust is characteristic of solvent drainage within the foam, coupled with rapid solvent evaporation at the printed structures' outer surface. A slight elongation of the pores along the printing direction can be distinguished at the crust surface for the foams with higher TiO₂ content, which is attributed to the effects of the shear stress exerted to the foams while printing. This is ultimately providing further means to induce some ordering in these mesoporous structures, as it is known that paste-like systems exhibit plastic memory when subjected to externally applied stresses¹⁰². In particular, it has been reported that the alignment of dispersed nanomaterials using CDW is likely to occur when their characteristic size is comparable to the dispensing nozzle diameter¹⁰³, thus, the present invention's foams, being colloidal suspensions, can be considered as similar systems, where the “nanomaterials” are replaced by gas bubbles or micellar formations of the oil-aqueous/TiO₂ mixture. However, at the inner regions of the foams, the drained solvent contributes to the relaxation and coalescence of inner gas bubbles, after the shear stress is applied during printing. Scanning electron microscopy (SEM) observation of the inner surface of the foams' pores show similar TiO₂ particle assembly characteristics irrespectively of the foam morphology, i.e. open- or closed-cell. However, slightly rougher inner macro-pore surfaces are observed in the case of L75-S5.5-O19.5 MEA foam, which correlates with the difference in the measured BET surface area (Table 2—Appendix I section). This can be used to further control the microstructure of these foams systems based on the choice of emulsifiers.

The effects of tuning the microstructure and morphology of the foams can be observed in their post-processing (i.e. sintering), surface properties and functional performance (e.g. heterogeneous photocatalysis). TGA (thermogravimetric analysis) curves of the different foams were performed and exhibited inflection points at ˜150° C., 350° C. and 450° C. These correspond in order to: end of solvent evaporation, organics decomposition (i.e. TALH to TiO₂ transformation and oil phase decomposition), and amorphous TiO₂ to anatase phase transformation, in agreement with previous observations for similar TiO₂-TALH systems⁸⁶. The studied formulations yield different amounts of TiO₂ depending on their constituents. The AE, defined as the % mass ratio between the target compound (material) and its precursors^{104, 105} can be estimated from our materials design and the TGA results. Thus, the foams formulated with higher amounts of primary TiO₂ particles (5.5 vol %)—corresponding to 18.17% of the total weight of the initial wet-foams, yield ˜21.95% of TiO₂ after sintering as measured using TGA, (19.68 wt % theoretical, also AE). Similarly, the foams with smaller amounts of primary TiO2 particles (3 vol %), corresponding to 9.91 wt % of the initial wet-foams, yield ˜13.31 wt % of TiO2 solids after sintering (TGA measured); with a theoretical AE of 10.74 wt %. The increase in TiO2 after sintering is expected because the TALH (Ti-organic complex), is also transformed into TiO2. Here, the choice of TAHL:TiO₂ ratio significantly affects the yield of TiO₂ solids, increasing to 23.13% (TGA measured) when using 1:6 TALH:TiO₂ mol ratio, theoretical AE of 24.23%. The sintered foams correspond to 92.3 wt % TiO₂ primary particles and 7.7 wt % TiO₂ from TALH for the 1:12 TAHL:TiO₂ mol ratio formulations; and to 75 wt % TiO₂ primary particles and 25 wt % TiO₂ from TALH, for the 1:6 TALH:TiO₂ mol ratio formulations, respectively. Therefore, it is found that the TALH:TiO₂ ratio has a great effect in changing the foams' surface properties as highlighted from the BET measurements (see Table 2—Appendix I section). Additional sources of variability between the expected TiO2 solids yield and the experimentally obtained, may be attributed to the loss of weight due to solvent volatilization during frothing.

Dimensional changes associated with sintering of ceramics are usually expected to occur and still need further understanding on a fundamental level⁵⁹. In our case, we postulate that by dispersing the oil phase to an already continuous aqueous phase—containing the TiO₂ primary particles and TALH—the aqueous network remains coherent. During frothing, the oil droplets become smaller and aid in the stabilization of the gas bubbles; which in turn may serve as pressure reservoirs influencing the volatilization of the solvent in the foam cell walls. Then, as the solvent is evacuated, the oil-stabilized primary particles tend to agglomerate and remain suspended in the predominantly oil scaffold. The melting temperature of the oil phase may play an additional role by solidifying and providing a stronger scaffold as it increases. Here the cells—when open—serve as solvent evacuation pathways, which can diffuse towards the outer surface of the printed object (crust), or towards the inner cell cavities. The extra surface for solvent evaporation, provided by the open-cell microstructures, helps to equilibrate rates of solvent diffusion (within the colloidal suspension towards the evaporation front), and the evaporation rate at the liquid-gas interface, which has been reported as a key mechanism to prevent cracking of ceramic colloidal films¹⁰⁶. Next, upon sintering, further shrinkage occurs when the oil phase is eliminated. However, the aggregation forces between the particles prevent the collapse of the foam structure by self-locking the primary particles thus limiting their relative displacement as sintering progresses. Printed hollow open-cell column shrinkage is found to lay around 16% in all directions; whereas closed-cell foam configurations exhibited a greater shrinkage in the z-direction of ˜25%. In the case of planar structures, anisotropic shrinkage is observed due to the constrained x and y bonding of the printed layer to the substrate, this change is approximately 25% in the z-direction for open-cell structures and 37% for closed-cell structures, respectively. The greater dimensional change experienced by the foams with closed-cell structures is attributed to the effects of the inter-particle forces, being larger for higher particle concentration formulations. These are weaker for open-cell architectures, as opposed to closed-cell foams, where the TiO₂ primary content is higher, since the compressive yield-stress associated to volumetric changes is known to be strongly dependent on the particle-particle interactions¹⁰⁶. Additionally, it is postulated that the inner surfaces of the open-cell foams, being larger in relation to the TiO₂ wall thickness, as observed using SEM, provide larger stress-release surfaces. Finally, the correlation of the volumetric contraction and the weight decrease after sintering is also indicative of the strong particle-particle interactions influence in the microstructural evolution of these foams. Since it is observed that such contraction is minimum for those foams experiencing larger weight decrease with sintering (i.e. L75-S3-O22 foams), as observed from TGA.

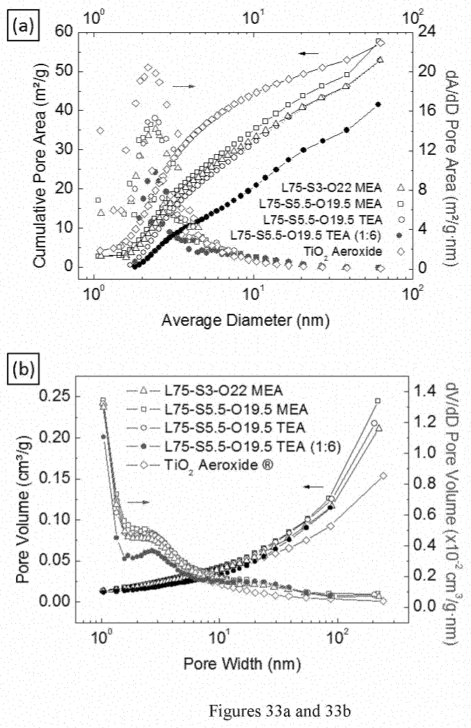

Photocatalysis results indicate that the foam films with open-cell structures perform better than their closed-cell counterparts in degrading MB, see Table 2-Appendix I section; where the apparent first-order degradation rate constant kapp are greater (with respect to the respective solids content and surfactant type). This result can be attributed to the inherent ability of open-cell structures to facilitate better circulation of the MB solution, and their availability for decomposition at TiO₂ photoactive surfaces. The heterogeneous photocatalytic degradation of MB over time was observed. In the case of closed-cell structures, the TiO₂ network is more compact, thus inhibiting the diffusion of UV light through inner regions of the film. On the other hand, the open-cell structures allow a greater depth of UV light diffusion. In addition, it is observed that the films with closed-cell structures (i.e. L75-S5.5-O19.5 MEA and TEA), exhibit similar performance, suggesting no significant effects from the use of MEA or TEA as surfactants, but rather stronger dependence on the macropore size—light interactions. A slight improvement is noticed for the 1:6 TALH:TiO₂ TEA formulation with respect to its 1:12 counterpart; again suggesting a stronger photocatalytic activity dependence on the circulation properties than on the amount of measured Brunauer-Emmet-Teller (BET) surface area. Specifically, a correlation between the photocatalytic performance and cell configuration can be established, since such performance is maximized for open-cell architectures, despite exhibiting generally lower surface area. FIG. 33a shows a Barrett-Joyner-Halenda (BJH) cumulative surface area and pore area distributions which support this observation. The photocatalytic activity of the foams is comparable to similar mesoporous TiO₂ films¹⁰⁷ and TiO₂:TALH systems¹⁰² the latter exhibiting remarkably good performance due to the low specific energy treatments, which prevent their surface coarsening.

Additionally, the roughening or smoothening the surface of the TiO₂ primary particles (and consequently foam walls), can be induced based on the nucleation and crystallization of secondary TiO₂ from TALH⁸⁶. Porosimetry measurements shown in FIG. 33b show no significant difference in the overall pore size distribution for all the foams studied (when keeping the same TALH:TiO₂ ratio) and the primary TiO₂ nanoparticles. The rather invariable character of these distributions, suggest that the microporosity of the foams is driven by the primary nanoparticles' concentration, size and surface properties. The pores' diameters span from ˜1 to 250 nm, comprising micro- meso- and macro-porosity regimes. Nevertheless, the variation of the TALH:TiO₂ ratio may be used to modify such distributions; for the 1:6 TALH:TiO₂ L75-S5.5-019.5 TEA foam, the surface area decreased with respect to all previous foam systems (with 1:12 TAHL:TiO₂ mole ratio) and to the TiO₂ primary particles; while reducing the porosity in the micro- and meso-pore regimes.

TABLE 2
Apparent first-order degradation rate constant kapp and
Brunauer-Emmett-Teller (BET) surface area.

| | kapp | BET Surface Area |
|---|---|---|
| Foam** | ×10⁻² min⁻¹ | m²/g |
| Blank | 0.103 | — |
| L75-S3-O22 MEA | 0.418 | 46.094 |
| L75-S5.5-O19.5 MEA | 0.262 | 49.556 |
| L75-S5.5-O19.5 TEA | 0.205 | 46.766 |
| L75-S5.5-O19.5 TEA (1:6) | 0.269 | 37.218 |
| Primary TiO2 Particles | — | 46.171 |

**Amount of liquid-solid-oil (L-S-O) in vol %.

XRD studies confirm the primary particles' properties to drive the microstructural characteristics of the foams, where the TiO₂ crystallite size show no significant coarsening even after the 500° C. sintering process. The broadening of the XRD characteristic peaks with respect to those of the primary TiO₂ particles, is attributed to the formation of nanocrystallites from the TALH transformation into TiO₂ which lowers their average size, as reported in our previous work⁸⁶. The change in crystallite size for the 1:6 TALH:TiO₂ foam formulation, shows an increase of about 11.4 and 3.4% for the rutile and anatase crystallites, respectively. The latter result, contrasts those for the TALH:TiO₂ 1:12 systems which exhibited a general decrease up to ˜6.8%. Furthermore, the calculated lattice parameters, with a standard deviation below 0.0118 Å with respect to those reported in literature¹⁰⁸ display a general decrease—with respect to that calculated for the primary TiO₂ particles—that accentuates more as the TALH amount is increased. Such decrease is maximum for the 1:6 formulation and it is attributed to the larger amount of N available (from TALH). This excess amount of N may result in interstitial or substitutional doping¹⁰⁹ of the TiO₂ in place of O, due to their similar atomic size and electronegativity.

As can be observed through our analysis of the proposed foam systems, the different compounds utilized for their synthesis are bio-compatible, non-toxic and water-stable. This signifies that the foams' processing does not require special humidity or vacuum conditions, and that there is ample time for these materials' manipulation. Moreover, because of the excellent bio-compatibility of all of the foam precursors (besides TiO₂), the synthesized cellular structures are natural candidates for their bio-functionalization or implementation as biocomponents. We have shown how, our ceramic foam synthesis approach offers fine tailoring of the morphology, surface area and pore-size distributions; and mass/light transport interactions (photocatalytic performance) based on the careful selection of the TALH:TiO₂ ratio, L:S:O ratio, and primary TiO₂ particle properties. Moreover, our method enables the 3D printing of these hierarchically ordered mesoporous structures as free-standing and spanning architectures by tuning the rheological properties of the yield-stress fluid formulations.

In need of pioneering approaches for responsibly engineered materials and manufacturing, we demonstrate a practical and relatively simple route to synthesize TiO₂ foams (that could be extended to other ceramic materials systems), using colloidal emulsions consisting of a Ti-organic complex—TiO₂ particle's suspension as the aqueous phase, and controlling their morphology as printable open- or closed-cell foam architectures. We investigate their printing space using continuous-flow direct writing, and show that spanning structures can be fabricated at relatively low writing speeds and intermediate dispensing pressures due to minimum-to-moderate stretching of the printed foam filament. In addition, we postulate a potential mechanism for the dimensional change, as the printed foam-inks are transformed into sintered solids, when using heat treatments up to 500° C. We illustrate the differences in photocatalytic performance between open- and closed-cell printed foams, arising from the electron-photon interactions and macropore size dependence, i.e., from the more efficient circulation of the dye solution to the photocatalytically-active sites of the foam, and the improved diffusion of light within the larger macropore open-cell foam structures. The use of inexpensive, innocuous, and bio-compatible materials implemented in these foams, may hold the key for their implementation and scalable 3D printing, enabling a plethora of advanced technological applications.

FIG. 30 shows shear stress dependence on the shear rate for the studied foams. L-S-O amounts are in vol %; (1:6) indicates the TALH:TiO₂ mol ratio.

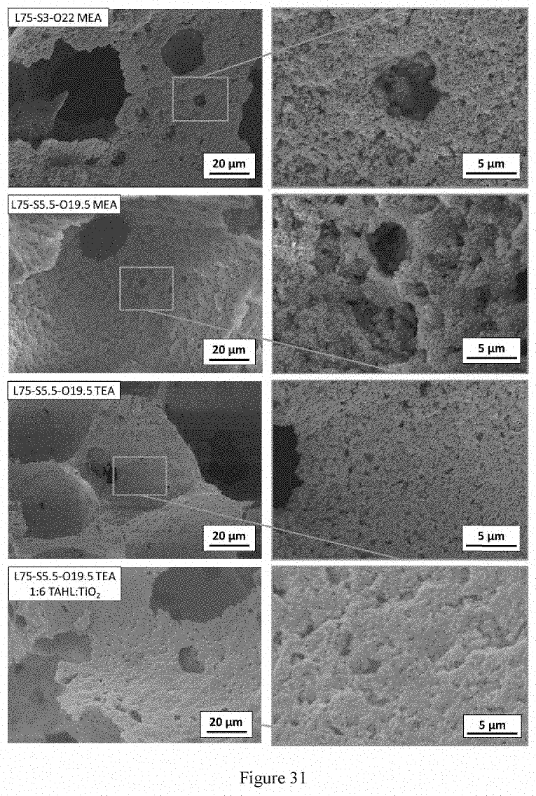

FIG. 31 shows scanning electron microscope images of the macro-pores inner surfaces for the different foams systems studied.

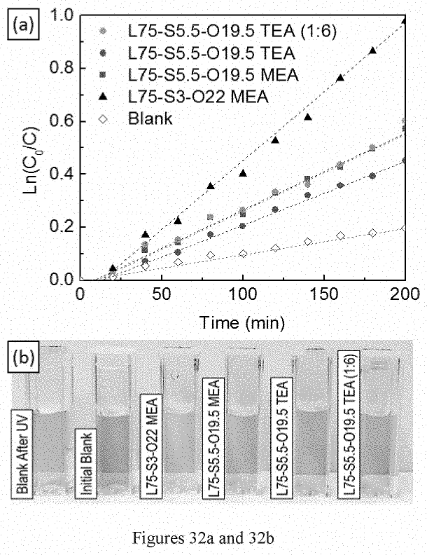

FIG. 32a shows a linearized methylene blue concentration change in time, undergoing heterogeneous photocatalytic degradation in the presence of the different TiO₂ foams under UV light exposure at λ=254 nm. FIG. 32b shows a photograph of cuvettes with degraded methylene blue solutions after 200 min of UV exposure.

FIG. 33a shows a Barrett-Joyner-Halenda (BJH) cumulative micro-pore area (black)(left facing arrow) and micro-pore area distribution (blue)(right facing arrow); and FIG. 33b shows a Horvath-Kawazoe micro-pore volume (black)(left facing arrow) and micro-pore volume distribution (green)(right facing arrow), for the primary TiO₂ nanoparticles and studied foam systems. The amount of liquid-solid-oil (L-S-O) is in vol %.

TABLE S7
Amount of anatase and rutile phases, and crystallite size
estimations from XRD**.

| | Crystalline Phase | | Grain Size (nm) | | Δ Grain Size (%) | |
|---|---|---|---|---|---|---|
| | Amount* | | Scherrer's | | w.r.t. TiO₂ | |
| | (wt. %) | | formula | | Aeroxide | |
| Foam | Rutile | Anatase | Rutile | Anatase | Rutile | Anatase |
| L75-S3-022 | 10.999 | 89.001 | 55.727 | 17.863 | −0.498 | −4.840 |
| MEA | | | | | | |
| L75-S5.5-019.5 | 11.303 | 88.697 | 52.220 | 18.077 | −6.759 | −3.698 |
| MEA | | | | | | |
| L75-S5.5-019.5 | 11.089 | 88.911 | 55.714 | 17.596 | −0.520 | −6.262 |
| TEA | | | | | | |
| L75-S5.5-019.5 | 11.068 | 88.932 | 62.391 | 19.401 | 11.401 | 3.356 |
| TEA | | | | | | |
| 1:6 | | | | | | |
| TiO₂ Aeroxide | 11.415 | 88.585 | 56.005 | 18.771 | 0.000 | 0.000 |

*Gribb et al.¹¹⁰
**Calculations using Gaussian peak fits. The amount of liquid-solid-oil (L-S-0) is in vol %.
(1:6) refers to TALH:TiO₂ mole ratio.

TABLE S8
Calculated lattice parameters for the TiO₂ primary particles,
and the resulting TiO₂ in the studied foam systems.

| | Crystalline | Lattice Parameter (Å) | |
|---|---|---|---|
| Foam* | Phase | a | c |
| L75-S3-O22 MEA | Anatase | 3.7936 | 9.5179 |
| | Rutile | 4.6007 | 2.9612 |
| L75-S5.5-O19.5 MEA | Anatase | 3.7970 | 9.5274 |
| | Rutile | 4.6059 | 2.9632 |
| L75-S5.5-O19.5 TEA | Anatase | 3.7921 | 9.5115 |
| | Rutile | 4.6007 | 2.9579 |
| L75-S5.5-O19.5 TEA | Anatase | 3.7861 | 9.5140 |
| 1:6 | Rutile | 4.5960 | 2.9581 |
| TiO2 Aeroxide ® | Anatase | 3.8010 | 9.5380 |
| | Rutile | 4.6106 | 2.9633 |

*The amounts of liquid-solid-oil (L-S-O) are given in vol %;
(1:6) refers to TALH:TiO₂ mole ratio.

### Abbreviations Used Herein

3D, 3-dimensional; AE, atom economy; TALH, titanium (IV) bis(ammonium lactacto) dihydroxide; DI, deionized; PAA, polyacrylic acid; SA, stearic acid; P60, polyoxoethylene sorbitan monostearate; MEA, eltanolamine; TEA, triethanolamine; L-S-O, liquid-solid-oil volume ratio; TEOS, tetraethoxysilane; PFPE, perfluoropolyether-alkoxysilane; XRD, X-ray diffraction; SEM, scanning electron microscopy; TGA, thermo-gravimetric analysis; MB, methylene blue; UV, ultra-violet; CDW, continuous-flow direct writing; BET, Brunauer-Emmet-Teller; BJH, Barrett-Joyner-Halenda.

### REFERENCES SET FORTH HEREIN

1 M. A. Tones Arango, D. Kwakye-Ackah, S. Agarwal, R. K. Gupta and K. A. Sierros, ACS Sustain. Chem. Eng., 2017, acssuschemeng.7b02450.
2 E. Dickinson, Food Hydrocoll., 2003, 17, 25-39.
3 E. Dickinson, Food Hydrocoll., 2017, 68, 219-231.
4 M. Glicksman, Food Hydrocolloids, CRC Press, Boca Raton, 1982.
5 B. Katzbauer, Polym. Degrad. Stab., 1998, 59, 81-84.
6 M. R. Sommer, L. Alison, C. Minas, E. Tervoort, P. A. RUhs and A. R. Studart, Soft Matter, 2017, 13, 1794-1803.
7 F. X. Xiao, S. F. Hung, J. Miao, H. Y. Wang, H. Yang and B. Liu, Small, 2015, 11, 554-567.
8 M. C. Wu, J. Hiltunen, A. Sapi, A. Avila, W. Larsson, H. C. Liao, M. Huuhtanen, G. Tóth, A. Shchukarev, N. Laufer, Á. Kukovecz, Z. Kónya, J. P. Mikkola, R. Keiski, W. F. Su, Y. F. Chen, H. Jantunen, P. M. Ajayan, R. Vajtai and K. Kordás, ACS Nano, 2011, 5, 5025-5030.
9 M. C. Wu, A. Sápi, A. Avila, M. Szabó, J. Hiltunen, M. Huuhtanen, G. Tóth, Á. Kukovecz, Z. Kónya, R. Keiski, W. F. Su, H. Jantunen and K. Kordás, Nano Res., 2011, 4, 360-369.
10 Y. C. Pu, G. Wang, K. Der Chang, Y. Ling, Y. K. Lin, B. C. Fitzmorris, C. M. Liu, X. Lu, Y. Tong, J. Z. Zhang, Y. J. Hsu and Y. Li, Nano Lett., 2013, 13, 3817-3823.
11 G. R. Bamwenda, S. Tsubota, T. Nakamura and M. Haruta, J. Photochem. Photobiol. A Chem., 1995, 89, 177-189.
12 J. Yu, L. Qi and M. Jaroniec, J. Phys. Chem. C, 2010, 114, 13118-13125.
13 W. T. Koo, S. J. Choi, S. J. Kim, J. S. Jang, H. L. Tuller and I. D. Kim, J. Am. Chem. Soc., 2016, 138, 13431-13437.
14 A. Sclafani, M.-N. Mozzanega and P. Pichat, J. Photochem. Photobiol. A Chem., 1991, 59, 181-189.
15 A. Pearson, H. Zheng, K. Kalantar-Zadeh, S. K. Bhargava and V. Bansal, Langmuir, 2012, 28, 14470-14475.
16 Q. Zhang, D. Q. Lima, I. Lee, F. Zaera, M. Chi and Y. Yin, Angew. Chemie—Int. Ed., 2011, 50, 7088-7092.
17 E. Formo, E. Lee, D. Campbell and Y. Xia, Nano Lett., 2008, 8, 668-672.
18 M. Es-Souni, M. Es-Souni, S. Habouti, N. Pfeiffer, A. Lahmar, M. Dietze and C. H. Solterbeck, Adv. Funct. Mater., 2010, 20, 377-385.
19 S. C. Chan and M. A. Barteau, Langmuir, 2005, 21, 5588-5595.
20 Y. Liu, S. Wei and W. Gao, J. Hazard. Mater., 2015, 287, 59-68.
21 F. Zhang, J. Chen, X. Zhang, W. Gao, R. Jin, N. Guan and Y. Li, Langmuir, 2004, 20, 9329-9334.
22 N. Lakshminarasimhan, A. D. Bokare and W. Choi, J. Phys. Chem. C, 2012, 116, 17531-17539.
23 N. Zhou, V. López-Puente, Q. Wang, L. Polavarapu, I. Pastoriza-Santos and Q.-H. Xu, RSC Adv., 2015, 5, 29076-29097.
24 Z. Zhang, Z. Wang, S. W. Cao and C. Xue, J. Phys. Chem. C, 2013, 117, 25939-25947.
25 Q. Lu, Z. Lu, Y. Lu, L. Lv, Y. Ning, H. Yu, Y. Hou and Y. Yin, Nano Lett., 2013, 13, 5698-5702.
26 C. Clavero, Nat. Photonics, 2014, 8, 95-103.
27 M. Y. Lan, C. P. Liu, H. H. Huang and S. W. Lee, PLoS One, 2013, 8, 4-11.
28 B. Yu, K. M. Leung, Q. Guo, W. M. Lau and J. Yang, Nanotechnology, 2011, 22, 115603.
29 I. Piwoński, K. Kdziola, A. Kisielewska, K. Soliwoda, M. Wolszczak, K. Lisowska, N. Wrońska and A. Felczak, Appl. Surf Sci., 2011, 257, 7076-7082.
30 B. O'Regan and M. Grätzel, Nature, 1991, 353, 737-740.
31 C. J. Ingham, J. ter Maat and W. M. de Vos, Biotechnol. Adv., 2012, 30, 1089-1099.
32 G. J. A. A. Soler-Illia and O. Azzaroni, Chem. Soc. Rev., 2011, 40, 1107-1150.
33 C. Hu, T. Lu, F. Chen and R. Zhang, J. Chinese Adv. Mater. Soc., 2013, 1, 21-39.
34 K. Qiu, M. Lu, Y. Luo and X. Du, J. Mater. Chem. A, 2017, 5, 5820-5828.
35 V. M. Jimenez, J. A. Mejias, J. P. Espinós and A. R. González-Elipe, Surf Sci., 1996, 366, 545-555.
36 M. Sanchez-Dominguez, K. Pemartin and M. Boutonnet, Curr. Opin. Colloid Interface Sci., 2012, 17, 297-305.
37 M. A. Torres Arango, A. S. Valenta de Andrade, D. T. Cipollone, L. O. Grant, D. Korakakis and K. A. Sierros, ACS Appl. Mater. Interfaces, 2016, 8, 24659-24670.
38 D. Saha and S. Bhattacharya, J. Food Sci. Technol., 2010, 47, 587-597.
39 K. W. Song, Y. S. Kim and G. S. Chang, Fibers Polym., 2006, 7, 129-138.
40 D. J. Pettitt, in Food Hydrocolloids Volume I, ed. M. Glicksman, CRC Press, Boca Raton, 1982, pp. 127-149.
41 L. Jeong and W. H. Park, Int. J. Mol. Sci., 2014, 15, 6857-6879.
42 F. García-Ochoa, V. E. Santos, J. A. Casas and E. Gómez, Biotechnol. Adv., 2000, 18, 549-579.
43 E. Santanach Carreras, F. Chabert, D. E. Dunstan and G. V. Franks, J. Colloid Interface Sci., 2007, 313, 160-168.
44 Y. Ohko, T. Tatsuma, T. Fujii, K. Naoi, C. Niwa, Y. Kubota and A. Fujishima, Nat. Mater., 2003, 2, 29-31.
45 J. Tauc, MRS Bull., 1968, 3, 37-46.
46 A. L. Linsebigler, G. Lu and J. T. Yates, Chem. Rev., 1995, 95, 735-758.
47 L. Gharibshahi, E. Saion, E. Gharibshahi, A. Shaari and K. Matori, Materials (Basel)., 2017, 10, 402.
48 K. Wenderich and G. Mul, Chem. Rev., 2016, 116, 14587-14619.
49 J. Prakash, P. Kumar, R. A. Harris and C. Swart, Nanotechnology, 27, 1-20.
50 B. Xin, L. Jing, Z. Ren, B. Wang and H. Fu, J. Phys. Chem. B, 2005, 109, 2805-2809.
51 Y. Matsumoto, S. Ida and T. Inoue, J. Phys. Chem. C, 2008, 112, 11614-11616.
52 E. Saion and E. Gharibshahi, 2011, 7, 6-11.
53 E. Gharibshahi and E. Saion, Int. J Mol. Sci., 2012, 13, 14723-14741.
54 C. D. Wagner, Anal. Chem., 1972, 44, 967-973.
55 S. W. Gaarenstroom and N. Winograd, J. Chem. Phys., 1977, 67, 3500-3506.
56 M. P. Seah, J. Electron Spectros. Relat. Phenomena, 1998, 97, 235-241.
57 G. Schön, J. Tummavuori, B. Lindström, C. R. Enzell, C. R. Enzell and C.-G. Swahn, Acta Chem. Scand., 1973, 27, 2623-2633.
58 A. M. Ferraria, A. P. Carapeto and A. Maria, 2012, 86, 1988-1991.
59 Franks, G. V.; Tallon, C.; Studart, A. R.; Sesso, M. L.; Leo, S. Colloidal Processing: Enabling Complex Shaped Ceramics with Unique Multiscale Structures. J. Am. Ceram. Soc. 2017, 100 (2), 458-490.
60 Zampieri, A.; Colombo, P.; Mabande, G. T. P.; Selvam, T.; Schwieger, W.; Scheffler, F. Zeolite Coatings on Microcellular Ceramic Foams: A Novel Route to Microreactor and Microseparator Devices. Adv. Mater. 2004, 16 (9-10), 819-823.
61 Crossland, E. J. W.; Noel, N.; Sivaram, V.; Leijtens, T.; Alexander-Webber, J. a; Snaith, H. J. Mesoporous TiO2 Single Crystals Delivering Enhanced Mobility and Optoelectronic Device Performance. Nature 2013, 495 (7440), 215-219.
62 Zhou, M.; Lin, T.; Huang, F.; Zhong, Y.; Wang, Z.; Tang, Y.; Bi, H.; Wan, D.; Lin, J. Highly Conductive Porous Graphene/ceramic Composites for Heat Transfer and Thermal Energy Storage. Adv. Funct. Mater. 2013, 23 (18), 2263-2269.
63 Rezwan, K.; Chen, Q. Z.; Blaker, J. J.; Boccaccini, A. R. Biodegradable and Bioactive Porous Polymer/inorganic Composite Scaffolds for Bone Tissue Engineering. Biomaterials 2006, 27 (18), 3413-3431.
64) Minas, C.; Carnelli, D.; Tervoort, E.; Studart, A. R. 3D Printing of Emulsions and Foams into Hierarchical Porous Ceramics. Adv. Mater. 2016, 28 (45), 9993-9999.
65 Muth, J. T.; Dixon, P. G.; Woish, L.; Gibson, L. J.; Lewis, J. A. Architected Cellular Ceramics with Tailored Stiffness via Direct Foam Writing. Proc. Natl. Acad. Sci. 2017, No. 34, 201616769.
66 Gonzenbach, U. T.; Studart, A. R.; Tervoort, E.; Gauckler, L. J. Ultrastable Particle-Stabilized Foams. Angew. Chemie Int. Ed. 2006, 45 (21), 3526-3530.
67 Green, D. J.; Colombo, P. Cellular Ceramics: Intriguing Structures, Novel Properties, and Innovative Applications. Mater. Res. Soc. 2003, 28 (4), 296-300.
68 Anastas, P. T.; Warner, J. C. Green Chemistry: Theory and Practice, Oxford University Press: New York, 1998; pp 30.
69 Kalustian, P. Pharmaceutical and Cosmetic Uses of Palm and Lauric Products. J. Am. Oil Chem. Soc. 1985, 62 (2), 431-433.
70 Magg, H. Fatty Acid Derivatives: Important Surfactants for Household, Cosmetic and Industrial Purposes. J. Am. Oil Chem. Soc. 1984, 61 (2), 259-267.
71 Baskaran, S.; Song, L.; Liu, J.; Chen, Y. L.; Graff, G. L. Titanium Oxide Thin Films on Organic Interfaces through Biomimetic Processing. J. Am. Ceram. Soc. 1998, 81 (2), 401-408.
72 Wang, P.; Wang, J.; Wang, X.; Yu, H.; Yu, J.; Lei, M.; Wang, Y. One-Step Synthesis of Easy-Recycling TiO2-rGO Nanocomposite Photocatalysts with Enhanced Photocatalytic Activity. Appl. Catal., B 2013, 132-133, 452-459.
73 Imhof, A.; Pine, D. J. Preparation of Titania Foams. Adv. Mater. 1999, 11 (4), 311-314.
74 Carn, F.; Colin, A.; Achard, M. F.; Deleuze, H.; Sanchez, C.; Backov, R. Anatase and Rutile TiO2 Macrocellular Foams: Air-Liquid Foaming Sol-Gel Process towards Controlling Cell Sizes, Morphologies, and Topologies. Adv. Mater. 2005, 17 (1), 62-66.
75 Collins, A. M.; Spickermann, C.; Mann, S. Synthesis of Titania Hollow Microspheres Using Non-Aqueous Emulsions. J. Mater. Chem. 2003, 13 (5), 1112-1114.
76 Chen, C.; Long, M.; Cai, W.; Zhou, B. Synthesis and Photocatalytic Application of Hierarchical Macroporous tio2 with Mesocellular Foam Structure Using Eggshell Membrane as Template. 2010 4th Int. Conf. Bioinforma. Biomed. Eng. 2010, 2-5.
77 Krishnappa, M.; Souza, V. S.; Ganganagappa, N.; Scholten, J. D.; Teixeira, S. R.; Dupont, J.; Thippeswamy, R. Mesoporous Foam TiO2 Nanomaterials for Effective Hydrogen Production. Chem.—A Eur. J. 2015, 21 (49), 17624-17630.
78 Ibhadon, A. O.; Greenway, G. M.; Yue, Y.; Falaras, P.; Tsoukleris, D. The Photocatalytic Activity of TiO2 Foam and Surface Modified Binary Oxide Titania Nanoparticles. J. Photochem. Photobiol. A 2008, 197 (2-3), 321-328.
79 Tytgat, T.; Smits, M.; Lenaerts, S.; Verbruggen, S. W. Immobilization of TiO2 into Self-Supporting Photocatalytic Foam: Influence of Calcination Temperature. Int. J. Appl. Ceram. Technol. 2014, 11 (4), 714-722.
80 Haugen, H.; Will, J.; Köhler, A.; Hopfner, U.; Aigner, J.; Wintermantel, E. Ceramic TiO2-Foams: Characterisation of a Potential Scaffold. J. Eur. Ceram. Soc. 2004, 24 (4), 661-668.
81 Chen, L.; Huang, C.; Xu, G.; Hutton, S. L.; Miao, L. Macroporous TiO2 Foam with Mesoporous Walls. Mater. Charact. 2013, 75, 8-12.
82 Jiang, Y.; Chen, G.; Xu, X.; Chen, X.; Deng, S.; Smirnov, S.; Luo, H.; Zou, G. Direct Growth of Mesoporous Anatase TiO2 on Nickel Foam by Soft Template Method as Binder-Free Anode for Lithium-Ion Batteries. RSC Adv. 2014, 4 (90), 48938-48942.
83 Banerjee, D. A.; Kessman, A. J.; Cairns, D. R.; Sierros, K. A. Tribology of Silica Nanoparticle-Reinforced, Hydrophobic Sol-gel Composite Coatings. Surf. Coatings Technol. 2014, 260, 214-219.
84 Aveyard, R.; Binks, B. P.; Clint, J. H. Emulsions Stabilised Solely by Colloidal Particles. Adv. Colloid Interface Sci. 2003, 100-102, 503-546.
85 Agarwal, S.; Phuoc, T. X.; Soong, Y.; Martello, D.; Gupta, R. K. Nanoparticle-Stabilised Invert Emulsion Drilling Fluids for Deep-Hole Drilling of Oil and Gas. Can. J. Chem. Eng. 2013, 91 (10), 1641-1649.
86 Tones Arango, M. A.; Valença de Andrade, A. S.; Cipollone, D. T.; Grant, L. O.; Korakakis, D.; Sierros, K. A. Robotic Deposition of TiO2 Films on Flexible Substrates from Hybrid Inks: Investigation of Synthesis-Processing-Microstructure-Photocatalytic Relationships. ACS Appl. Mater. Interfaces 2016, 8 (37), 24659-24670.
87 Gutierrez-Tauste, D.; Zumeta, I.; Vigil, E.; Hernandez-Fenollosa, M. A.; Domènech, X.; Ay116n, J. a. New Low-Temperature Preparation Method of the TiO2 Porous Photoelectrode for Dye-Sensitized Solar Cells Using UV Irradiation. J. Photochem. Photobiol. A 2005, 175 (2-3), 165-171.
88 Saint-Jalmes, A. Physical Chemistry in Foam Drainage and Coarsening. Soft Matter 2006, 2 (10), 836-849.
89 Herschel, W. H.; Bulkley, R. Konsistenzmessungen von Gummi-Benzollosungen. Kolloid-Z. 1926, 39 (4), 291-300.
90 Gupta, R. K. Gas-Containing Melts and Foams. In Polymer and Composite Rheology; Marcel Dekker: New York, 2000; pp 304-315.
91 Lewis, J. A.; Gratson, G. M. Direct Writing in Three Dimensions. Mater. Today 2004, 7 (7-8), 32-39.
92 Cesarano, J.; Segalman, R.; Calvert, P. Robocasting Provides Moldless Fabrication from Slurry Deposition. Ceram. Ind. 1998, 148 (4), 94-101.
93 Xu, Q.; Lv, Y.; Dong, C.; Sreeprased, T. S.; Tian, A.; Zhang, H.; Tang, Y.; Yu, Z.; Li, N. Three-Dimensional Micro/nanoscale Architectures: Fabrication and Applications. Nanoscale 2015, 7 (25), 10883-10895.
94 Raney, J. R.; Lewis, J. A. Printing Mesoscale Architectures. MRS Bull. 2015, 40 (11), 943-950.
95 Ge, M.; Cao, C.; Huang, J.; Li, S.; Chen, Z.; Zhang, K.-Q.; Al-deyab, S. S.; Lai, Y. A Review of One-Dimensional TiO2 Nanostructured Materials for Environmental and Energy Applications. J. Mater. Chem. A 2016, 4, 6772-6801.
96 Stuecker, J. N.; Cesarano, J.; Hirschfeld, D. A. Control of the Viscous Behavior of Highly Concentrated Mullite Suspensions for Robocasting. J. Mater. Process. Technol. 2003, 142 (2), 318-325.
97 Zocca, A.; Colombo, P.; Gomes, C. M.; Günster, J. Additive Manufacturing of Ceramics: Issues, Potentialities, and Opportunities. J. Am. Ceram. Soc. 2015, 98 (7), 1983-2001.
98 Rueschhoff, L.; Costakis, W.; Michie, M.; Youngblood, J.; Trice, R. Additive Manufacturing of Dense Ceramic Parts via Direct Ink Writing of Aqueous Alumina Suspensions. Int. J. Appl. Ceram. Technol. 2016, 13 (5), 821-830.
99 Feilden, E.; Blanca, E. G.-T.; Giuliani, F.; Saiz, E.; Vandeperre, L. Robocasting of Structural Ceramic Parts with Hydrogel Inks. J. Eur. Ceram. Soc. 2016, 36 (10), 2525-2533.
100 Gonzenbach, U. T.; Studart, A. R.; Tervoort, E.; Gauckler, L. J. Macroporous Ceramics from Particle-Stabilized Wet Foams. J. Am. Ceram. Soc. 2007, 90 (1), 16-22.
101 Chuanuwatanakul, C.; Tallon, C.; Dunstana, D. E.; Franks, G. V. Controlling the Microstructure of Ceramic Particle Stabilized Foams: Influence of Contact Angle and Particle Aggregation. Soft Matter 2011, 7, 11464-11474.
102 Nakahara, A.; Matsuo, Y. Transition in the Pattern of Cracks Resulting from Memory Effects in Paste. Phys. Rev. E 2006, 74, 045102(1-4).
103 Compton, B. G.; Lewis, J. A. 3D-Printing of Lightweight Cellular Composites. Adv. Mater. 2014, 26 (34), 5930-5935.
104 Trost, B. M. The Atom Economy-A Search for Synthetic Efficiency. Science 1991, 254 (5037), 1471-1477.
105 Tabone, M. D.; Cregg, J.; Beckman, E.; Landis, A. E. Sustainability Metrics: Life Cycle Assessment and Green Design in Polymers. Environ. Sci. Technol. 2010, 44 (21), 8264-8269.
106 Santanach Carreras, E.; Chabert, F.; Dunstan, D. E.; Franks, G. V. Avoiding “mud” Cracks during Drying of Thin Films from Aqueous Colloidal Suspensions. J. Colloid Interface Sci. 2007, 313 (1), 160-168.
107 Du, J.; Lai, X.; Yang, N.; Zhai, J.; Kisailus, D.; Su, F.; Wang, D.; Jiang, L. Hierarchically Ordered Macro-Mesoporous TiO2—Graphene Composite Films: Improved Mass Transfer, Reduced Charge Recombination, and Their Enhanced Photocatalytic Activities. ACS Nano 2011, 5 (1), 590-596.
108 Linsebigler, A. L.; Lu, G.; Yates, J. T. Photocatalysis on TiO2 Surfaces: Principles, Mechanisms, and Selected Results. Chem. Rev. 1995, 95 (3), 735-758.
109 Di Valentin, C.; Finazzi, E.; Pacchioni, G.; Selloni, A.; Livraghi, S.; Paganini, M. C.; Giamello, E. N-Doped TiO2: Theory and Experiment. Chem. Phys. 2007, 339 (1-3), 44-56.
110 Gribb, A. A.; Banfield, J. F. Particle Size Effects on Transformation Kinetics and Phase Stability in Nanocrystalline TiO₂. Am. Mineral. 1997, 82 (7-8), 717-728.

It will be appreciated by those persons skilled in the art that changes could be made to embodiments of the present invention described herein without departing from the broad inventive concept thereof. It is understood, therefore, that this invention is not limited by any particular embodiments disclosed, but is intended to cover the modifications that are within the spirit and scope of the invention, as defined by the appended claims.

What is claimed is:

1. A composition comprising a hierarchical cellular mesoporous metal-oxide.

2. The composition of claim 1 wherein the hierarchical cellular mesoporous metal oxide is a metal organic/metal oxide.

3. The composition of claim 2 wherein said metal organic/metal oxide is TALH:TiO₂.

4. The composition of claim 1 wherein said hierarchical cellular mesoporous metal-oxide is an Ag—TiO₂ xanthan gum based film.

5. The composition of claim 1 wherein said hierarchical cellular mesoporous metal-oxide is an Ag—TiO₂ oil based foam.

6. The composition of claim 1 wherein said hierarchical cellular mesoporous metal-oxide is in the form of a three dimensional printed hierarchical based structure.

7. The composition of claim 6 wherein said three dimensional structure is on a ITO/glass substrate.

8. The composition of claim 6 wherein said composition is in the form of a film, spanning structure, or a hollow structure.

9. The composition of claim 1 wherein said hierarchical cellular mesoporous metal-oxide is in the form of a planar hierarchical structure.

10. The composition of claim 9 wherein said planar hierarchical structure is on a ITO/glass substrate.

11. The composition of claim 9 wherein said composition is in the form of a film, spanning structure, or a hollow structure.

12. A method of making a hierarchical cellular mesoporous metal oxide composition comprising:
providing a metal-organic/metal oxide aqueous phase,
providing a silver-ion rich oil phase,
emulsifying said metal-organic/metal oxide aqueous phase and said silver ion rich oil phase to form an emulsified component, and
incorporating gas bubbles into said emulsified component by subjecting said emulsified component to frothing to form a hierarchical cellular mesoporous metal oxide composition.

13. The method of claim 12 wherein said metal-organic/metal oxide aqueous phase is TALH:TiO₂.

14. A method of making a hierarchical cellular mesoporous metal oxide composition comprising:
providing a metal-organic/metal oxide aqueous phase,
providing a silver acetate ethanol solution,
adding triethanolamine to said silver acetate ethanol solution to form a triethanolamine silver acetate ethanol mixture,
providing an oil phase,
adding said triethanolamine silver acetate ethanol mixture to said oil phase to form an triethanolamine silver acetate ethanol oil phase component,
evaporating said ethanol rom said triethanolamine silver acetate ethanol oil phase to form an ethanolamine silver acetate oil phase, and
adding said metal-organic/metal oxide aqueous phase to said ethanolamine silver acetate oil phase to form an metal-organic/metal oxide phase dispersed in said oil phase to form a homogenized mixture of said metal-organic/metal oxide aqueous phase and said oil phase.

15. The method of claim 14 wherein the metal-organic/metal oxide aqueous phase is TALH:TiO2.

16. A method of making a hierarchical cellular mesoporous metal oxide composition comprising:
providing a metal-organic/metal oxide aqueous phase,
providing a silver precursor component solubilized in ethanol solution,
mixing said silver precursor component solubilized in ethanol in a polyacrylic acid-xanthum gum solution to form a silver polyacrylic acid-xanthum gum mixture, and
mixing said silver polyacrylic acid-xanthum gum mixture into said metal-organic/metal oxide aqueous phase to form said hierarchical cellular mesporous metal oxide composition.

17. The method of claim 16 wherein said metal-organic/metal oxide is TALH:TiO₂.

18. A method of making a hierarchical cellular mesoporous metal oxide composition comprising:
providing a metal-organic/metal oxide aqueous phase,
providing a silver precursor component,
mixing said silver precursor component in a polyacrylic acid-xanthum gum solution to form a silver polyacrylic-acid-xanthum gum mixture, and
mixing said silver polyacrylic-xanthum gum mixture into said metal-organic/metal oxide aqueous phase to form a hierarchical cellular mesoporous oxide composition.

19. A method of making a hierarchical cellular mesoporous metal oxide composition comprising:
providing a metal-organic/metal oxide aqueous phase,
providing a silver precursor component solubilized in ethanol solution using ammonium hydroxide,
mixing said silver precursor component solubilized in ethanol in a polyacrylic acid-xanthum gum solution to form a silver polyacrylic-acid-xanthum gum mixture, and
mixing said silver polyacrylic-xanthum gum mixture into said metal-organic/metal oxide aqueous phase to form a hierarchical cellular mesoporous oxide composition.

20. A method of making an oil based hierarchical cellular mesoporous metal oxide composition comprising:
providing an oil phase composition comprising at least one of stearic acid, polyoxoethylene sorbitan monostearate, and lanolin,
providing a silver precursor component solubilized in ethanol solution,
adding at least one of ethanolamine or triethanolamine, or both, to said silver precursor component solubilized in ethanol to form an ethanolamine or triethanolamine or ethanolamine/triethanolamine and silver precursor component ethanol mixture,
evaporating said ethanol from said ethanolamine or triethanolamine or ethanolamine/triethanolamine and silver precursor component ethanol mixture to form an ethanolamine or triethanolamine or ethanolamine/triethanolamine and silver precursor component mixture,
providing a TiO₂ and TAHL aqueous solution,
adding polyacrylic acid to said TiO₂ and TAHL aqueous solution to form a polyacrylic acid TiO₂ and TAHL mixture,
adding said polyacrylic acid TiO₂ and TAHL mixture to said oil phase composition at a temperature of about 70 degrees centigrade to produce a homogenized mixture, and
incorporating gas bubbles into said homogenized mixture to form an oil based hierarchical cellular mesoporous metal oxide composition.

21. A method of making an oil-free hierarchical cellular mesoporous metal oxide composition comprising:
providing a TiO₂ and TAHL and deionized water aqueous solution,
providing a polyacrylic acid and a xanthan gum aqueous solution,
adding said polyacrylic acid and a xanthan gum aqueous solution to said TiO₂ and TAHL and deionized water aqueous solution to form a polyacrylic acid and a xanthan gum TiO₂ and TAHL and deionized water aqueous solution, and
incorporating gas bubbles into said polyacrylic acid and xanthan gum TiO₂ and TAHL and deionized water aqueous solution to form an oil free based hierarchical cellular mesoporous metal oxide composition oil free hierarchical cellular mesoporous metal oxide composition.

22. A method of making an oil-free silver decorated foam hierarchical cellular mesoporous metal oxide composition comprising:
providing a TiO₂ and TAHL and deionized water aqueous solution,
providing a polyacrylic acid and a xanthan gum aqueous solution,
adding said polyacrylic acid and a xanthan gum aqueous solution to said TiO₂ and TAHL and deionized water aqueous solution to form a polyacrylic acid and a xanthan gum TiO₂ and TAHL and deionized water aqueous solution,
providing a silver acetate solution,
adding ethanol to said silver acetate solution by solubilizing said ethanol and silver acetate solution with the addition of ammonium hydroxide aqueous solution to form an ethanol silver acetate solution, and wherein the silver acetate:ammonium hydroxide ratio is 1:9 mol,
adding said ethanol silver acetate solution to said polyacrylic acid and xanthum gum aqueous solution to form a homogenized ethanol silver acetate polyacrylic acid xanthum gum aqueous solution,
adding said homogenized ethanol silver acetate polyacrylic acid xanthum gum aqueous solution to said TiO₂ and TAHL and deionized water aqueous solution to form an ethanol silver acetate polyacrylic acid xanthum gum TiO₂ and TAHL and deionized water aqueous solution, and
incorporating gas bubbles into said ethanol silver acetate polyacrylic acid xanthum gum TiO₂ and TAHL and deionized water aqueous solution to form an oil free silver decorated foam hierarchical cellular mesoporous metal oxide composition.
